(19) United States
(12) Patent Application Publication
(10) Pub. No.: US 2003/0225696 A1
(43) Pub. Date: Dec. 4, 2003

(54) Customized multimedia content method, apparatus, media and signals

(76) Inventor: Paul Niwa, Boston, MA (US)

Correspondence Address: DARBY & DARBY P.C., P. O. BOX 5257, NEW YORK, NY, 10150-5257, US

(21) Appl. No.: 10/240,954

(22) PCT Filed: Apr. 6, 2001
(86) PCT No.: PCT/US01/11380

(30) Foreign Application Priority Data
Apr. 7, 2000 (US) 60195226
Aug. 23, 2000 (US) 60227019

(51) Int. Cl. G06F 17/60

(52) U.S. Cl. 705/50

(57) ABSTRACT

A method, apparatus, media and signals for presenting customized multimedia content are disclosed. The method involves causing video segments having information content associated with a particular subscriber and having smooth transition features, to be successively played to produce a continuous video program comprising the segments.

### FIELD OF THE INVENTION

The present invention relates to multimedia, and more particularly to methods, apparatus, media and signals for presenting customized multimedia content.

### BACKGROUND OF THE INVENTION

A variety of ways of obtaining text and/or multimedia information over a network such as the Internet presently exist. For example, one existing method involves a user downloading and installing specialized software on the user's computer, and using the specialized software to specify topics of interest, such as business news, travel features, or individual stocks, for example. The user may then configure the software to download text and still images relating to the specified topics of interest, either periodically or spontaneously in response to a user command. The user must then use the specialized software to manually navigate between individual documents relating to the topics of interest, viewing one such document at a time. If the user wishes to view a significant number of documents, such manual navigation may be inconvenient. In addition, the user may be presented with an unrealistically high number of documents to view, with the result that the user may have to waste time sifting through titles of news stories that are not actually of any interest to the user.

Another existing method involves a user navigating to a central web server using a web browser. The user may manually select up to three video clips, identified by broad, static titles such as “top story” or “sports” for example. The web server then presents the video clips sequentially in a newscast. However, the necessity of manually selecting the video clips of interest may be inconvenient to the user.

In addition, the video clips available on the server are intended to be of general interest, and the selection of a clip identified by a broad title such as “movies” may result in a user being presented with superfluous information in which the user is not actually interested. In addition, when two video segments are played sequentially to form a newscast, this may result in a “jump cut”, which is a visual discontinuity which occurs when two similar scenes corresponding to different moments in time are spliced together. For example, in a typical television newscast, each story might include video of the news announcer or anchor introducing the story, followed by narrated video footage of the subject of the story, followed by further video of the news anchors closing remarks relating to the story. If the first such story and the third such story were spliced together, removing the second story, for example, the position of the news anchor on the television screen at the end of the first story would not precisely correspond to the anchor's position on the screen at the beginning of the third story, and as a result a viewer would observe a disconcerting instantaneous movement of the anchor from one position to another position.

Thus, there is a need for a way to conveniently provide relevant multimedia content to a user, while reducing the likelihood that jump cuts will occur.

### SUMMARY OF THE INVENTION

The present invention addresses the above need by providing, in accordance with one aspect of the invention, a method and apparatus for presenting customized multimedia content. The method involves causing video segments having information content associated with a particular subscriber and having smooth transition features, to be successively played to produce a continuous video program including the segments. The apparatus includes a processor circuit configured to cause the video segments to be successively played.

Causing video segments having information content associated with the particular subscriber to be successively played may reduce the likelihood that the subscriber will be presented with irrelevant information in which he or she is not interested, and may eliminate the need for the user to constantly provide manual instructions to play each segment in succession. Thus, a user may sit back and relax while the video segments are played. In addition, the smooth transition features serve to reduce or eliminate the occurrence of jump cuts, thereby improving the quality of the user's viewing experience.

The method preferably further involves identifying the video segments having information content associated with the particular subscriber. The processor circuit may be configured to perform this identification. For example, in one embodiment of the invention, a subscriber may simply log onto a server, which then automatically identifies video segments of interest to the particular subscriber. In addition to reducing the likelihood that the subscriber will be presented with superfluous information, this may further reduce the amount of manual interaction required on the part of the user.

Identifying the video segments preferably involves accessing a content database for content associated with at least one subscriber characteristic of the particular subscriber. The apparatus may include the content database in communication with the processor circuit, which may be configured to access the content database.

The method may further involve storing, in a subscriber database, at least one subscriber characteristic associated with each particular subscriber of a plurality of subscribers. The apparatus may therefore include a subscriber database in communication with the processor circuit, which may be configured to store the subscriber characteristic in the subscriber database.

The method may involve acquiring at least some of the subscriber characteristics from the subscribers. The processor circuit may be configured to achieve this.

Storing the at least one subscriber characteristic preferably includes storing an identification of an investment holding of the particular subscriber, and may also include storing an identification of at least one transaction made by the particular subscriber relating to the investment holding. The processor circuit may be configured to store such characteristics. Thus, some embodiments of the invention are particularly beneficial to investors, as a particular investor may be presented with a customized newscast including successively played video segments having information content associated with that particular investor's investment holdings. The method also preferably involves monitoring communications between the particular subscriber and a service, and storing the at least one subscriber characteristic preferably involves producing a usage log of usage of the service by the particular subscriber. The processor circuit may be configured to monitor the communications, and to produce and store the usage log. Thus, in embodiments where the service is an informational website, for example, the apparatus may automatically identify video segments of interest to the user based on the user's navigation among web pages at the web site, even if the user has not manually entered subscriber characteristics indicative of the user's interest. Producing the usage log may involve recording a uniform resource locator specified by the particular subscriber. Alternatively, or in addition, producing the usage log may involve recording at least some source code associated with a resource identified by a uniform resource locator specified by the particular subscriber. The processor circuit may be configured to record the URL or the source code, as the case may be. Thus, by way of illustration, the processor circuit may automatically record an indication of the title of a web page, of a particular stock described in the web page, or of meta data describing the content of the web page, for example. This may allow for greater specificity of subscriber characteristics derived from monitoring the user's communications with the service, which in turn may allow for the system to identify video segments more closely associated with the particular subscriber.

Identifying an additional video segment may involve identifying a characteristic category associated with the at least one subscriber characteristic, and identifying other video segments associated with the characteristic category. For example, if the subscriber has a technology sector stock, an additional video segment associated with the technology sector may be identified. Alternatively, or in addition, identifying an additional video segment may involve identifying another video segment associated with a particular characteristic category, when the category is underrepresented in the continuous video program. Likewise, identifying an additional video segment may involve identifying another video segment in response to a video segment characteristic of a video segment already identified as having information content associated with the particular subscriber. The processor circuit may be configured to carry out such identifications.

Optimizing preferably involves eliminating from the program a video segment associated with a particular characteristic category, when the category is overrepresented in the continuous video program. Alternatively, or in addition, eliminating may involve eliminating from the program a video segment associated with a particular subscriber characteristic, in response to a transaction history associated with the particular subscriber and with the particular subscriber characteristic. In this regard, eliminating may involve eliminating the video segment when a change in a dynamic value associated with the particular subscriber characteristic is less than a threshold value derived from the transaction history. For example, if a particular subscriber's transaction history for a particular investment holding indicates that the subscriber is not likely to either buy or sell when a change in the value of the investment holding is less than a certain threshold change, the apparatus may intelligently decide to eliminate from the program a video segment corresponding to that investment holding, when the change in value of the investment holding is less than the threshold change. The processor circuit may be configured to eliminate the video segments in the above manners.

Optimizing the continuous video program may involve adjusting a proportion of content of the continuous video program in response to subscriber characteristics associated with the particular subscriber. Adjusting may involve adding to the continuous video program a video segment associated with a particular characteristic category, when the category is underrepresented in the continuous video program. Conversely, adjusting may involve eliminating from the continuous video program a video segment associated with a particular characteristic category, when the category is overrepresented in the continuous video program. The processor circuit may be configured to carry out such adjusting, adding and eliminating.

The method preferably also involves ordering the video segments into a playback sequence. Ordering may involve ordering the video segments according to relevance of each of the segments to the particular subscriber. The relevance of each of the segments to the particular subscriber may be determined in response to subscriber characteristics associated with the particular subscriber. Determining relevance may involve determining relevance in response to quantities of respective investment holdings associated with the particular subscriber. Ordering may also involve scheduling a first video segment of high relevance to the particular subscriber at a commencement of the playback sequence, and scheduling a second video segment of high relevance to the particular subscriber at an end of the playback sequence. The processor circuit may be configured to carry out such ordering, determining of relevance and scheduling.

Ordering may involve causing at least one general interest video segment having information content of general interest to subscribers to be played in the continuous video program. The processor circuit may be configured to achieve this.

The method preferably also involves causing at least one advertisement video segment to be played in the continuous video program, which the processor circuit may be configured to achieve.

Identifying video segments may involve identifying at least one advertisement video segment having information content associated with the particular subscriber. The processor circuit may be configured to perform this identification. Thus, in such an embodiment, even the advertisements in the video program may be intelligently selected so as to be of greater interest to a user than randomly selected ads.

The method preferably involves storing the video segments having the smooth transition features in a content database. Similarly, the apparatus preferably includes the content database in communication with the processor circuit, the content database storing the video segments having the smooth transition features.

Storing the video segments may involve storing video segments having, as the smooth transition features, opening and closing scenes of the video segments sufficiently dissimilar from each other to prevent jump cuts from a closing scene of one video segment to an opening scene of a following video segment. The step preferably involves causing to be successively played, video segments having opening and closing scenes of this type. The processor circuit may be configured to carry out such storing and causing.

In accordance with another aspect of the invention, there is provided an apparatus for presenting customized multimedia content. The apparatus includes means for causing video segments having information content associated with a particular subscriber and having smooth transition features, to be successively played to produce a continuous video program including the segments. The apparatus may further include means for identifying the video segments having information content associated with the particular subscriber.

In accordance with another aspect of the invention, there is provided a computer readable medium for providing instructions for directing a processor circuit to present customized multimedia content, by causing video segments having information content associated with a particular subscriber and having smooth transition features, to be successively played to produce a continuous video program including the segments.

In accordance with another aspect of the invention, there is provided a signal embodied in a carrier wave, the signal including a code segment for directing a processor circuit to cause video segments having information content associated with a particular subscriber and having smooth transition features, to be successively played to produce a continuous video program including the segments.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic representation of a system for presenting customized multimedia content, according to a first embodiment of the invention;

FIG. 2 is a tabular representation of a subscriber information table stored in a subscriber database shown in FIG. 1;

FIG. 3 is a fragmented tabular representation of a portfolio table stored in the subscriber database shown in FIG. 1;

FIG. 4 is a tabular representation of a companies table stored in the subscriber database shown in FIG. 1;

FIG. 5 is a tabular representation of a usage log stored in the subscriber database shown in FIG. 1;

FIG. 6 is a block diagram of the content database shown in FIG. 1;

FIG. 7 is a tabular representation of a content description table stored in the content database shown in FIG. 1;

FIG. 8 is a schematic representation of a video segment stored in the content database shown in FIG. 1;

FIG. 9 is a schematic representation of successive video segments of the type shown in FIG. 8 arranged to produce a continuous video program;

FIGS. 10A and 10B comprise a block diagram of a processor circuit of a server shown in FIG. 1;

FIGS. 11A and 11B comprise a flowchart of a content acquisition interface thread executed by the processor circuit shown in FIGS. 10A and 10B;

FIGS. 12A and 12B comprise a flowchart of a subscriber characteristics acquisition thread executed by the processor circuit shown in FIGS. 10A and 10B;

FIG. 13 is a screenshot of a first graphical user interface produced by the processor circuit shown in FIGS. 10A and 10B under the direction of the subscriber characteristics acquisition thread shown in FIGS. 11A and 11B;

FIG. 14 is a screenshot of a second graphical user interface produced by the processor circuit shown in FIGS. 10A and 10B under the direction of the subscriber characteristics acquisition thread shown in FIGS. 11A and 11B;

FIG. 15 is a screenshot of a third graphical user interface produced by the processor circuit shown in FIGS. 10A and 10B under the direction of the subscriber characteristics acquisition thread shown in FIGS. 11A and 11B;

FIG. 16 is a screenshot of an exemplary resource identified by a URL selected by a subscriber and recorded in a usage log by the processor circuit shown in FIGS. 10A and 10B under the direction of the subscriber characteristics acquisition thread shown in FIGS. 11A and 11B;

FIGS. 17A and 17B comprise a flowchart of a custom newscast routine executed by the processor circuit shown in FIGS. 10A and 10B;

FIGS. 18A and 18B comprise a flowchart of a data mining subroutine executed by the processor circuit shown in FIGS. 10A and 10B; and

FIGS. 19A and 19B comprise a flowchart of a data weeding subroutine executed by the processor circuit shown in FIGS. 10A and 10B.

### DETAILED DESCRIPTION

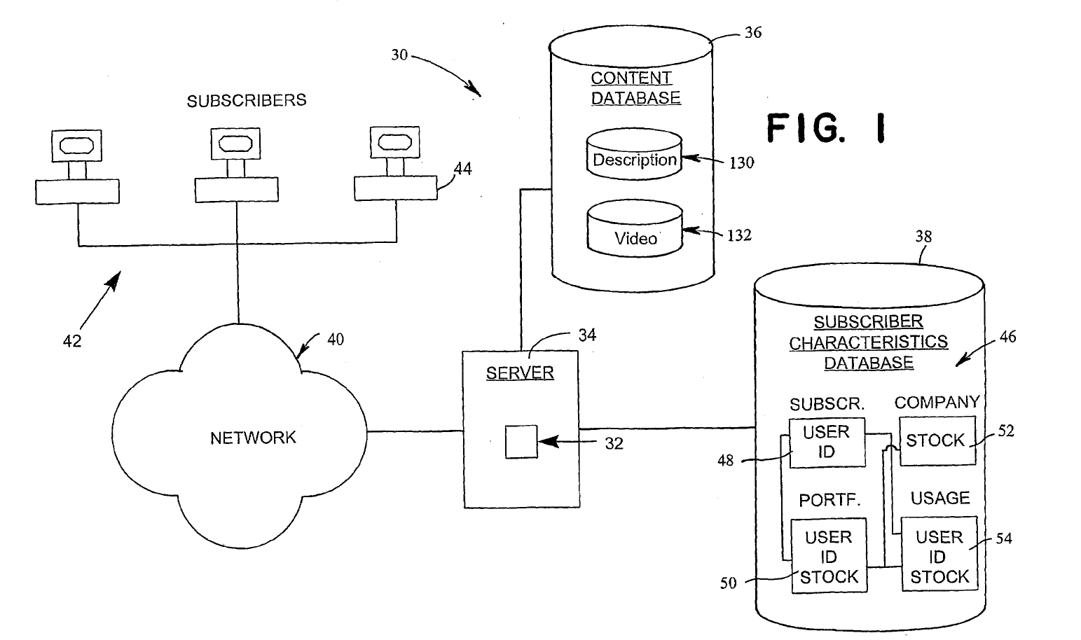

Referring to FIG. 1, an apparatus for presenting customized multimedia content according to a first embodiment of the invention is shown generally at 30. The apparatus includes a processor circuit shown generally at 32, configured to cause video segments having information content associated with a particular subscriber and having smooth transition features, to be successively played to produce a continuous video program including the segments.

More particularly, in this embodiment the processor circuit 32 is provided in a server shown generally at 34. The processor circuit 32 is in communication with a content database 36 and a subscriber database 38. The processor circuit 32 is also in communication, via a network 40, with a plurality of subscribers shown generally at 42, one particular subscriber being shown at 44 for illustrative purposes. In this embodiment, the network 40 is the public Internet, however, other networks may be substituted.

Although the databases 36 and 38 are illustrated as separate from the server 34, it will be appreciated that alternatively, the content databases may be integral with the server, or may be remote from the server and in communication therewith via any suitable means, such as a network or a wireless communication link, for example.

Subscriber Database

In this embodiment, the subscriber database 38 includes a relational database, in which a plurality of subscriber characteristics tables shown generally at 46 are stored.

More particularly, in this embodiment the subscriber characteristics tables 46 include a subscriber information table 48, a portfolio table 50, a companies table 52 and a usage log 54. However, other ways of storing and organizing subscriber characteristics may be apparent to one of ordinary skill in the art upon reading this specification. Such differences are not considered to depart from the scope of the invention as construed in accordance with the accompanying claims. Similarly, if desired, the subscriber database 38 may also include various other tables.

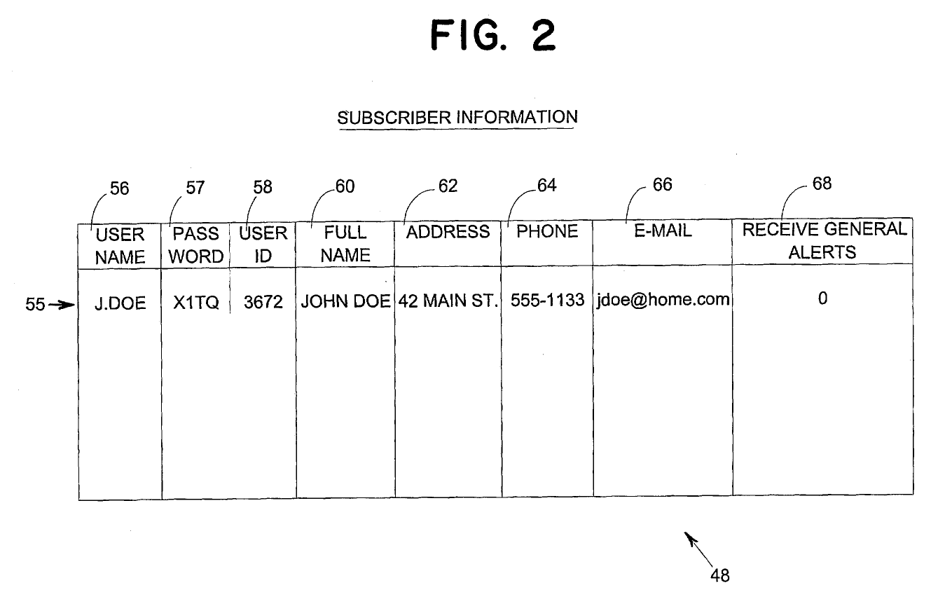

Referring to FIG. 2, the subscriber information table is shown generally at 48. The subscriber information table includes a plurality of subscriber information records, one of which is shown at 55. In this embodiment, each subscriber information record 55 includes a username field 56, a password field 57, a user ID field 58, a full name field 60, an address field 62, a phone field 64, an e-mail field 66 and a general alerts field 68.

The username field 56 is used to store an alphanumeric string entered by the subscriber to log on and to identify the subscriber on-line, and the password field 57 stores an alphanumeric password that the subscriber must enter to access certain on-line services, such as portfolio tracking of the subscriber's personal stock portfolio, for example.

The user ID field 58 stores a unique number generated and stored by the processor circuit 32 to uniquely identify each of the subscribers 42.

Each of the full name field 60, the address field 62, the phone field 64 and the e-mail field 66 stores alphanumeric data representing the name, address, telephone number and e-mail address of the subscriber, respectively.

The general alerts field 68 stores a bit set active or inactive to indicate whether the subscriber does or does not wish to receive general news alerts which are not necessarily related to any subscriber characteristic of the particular subscriber.

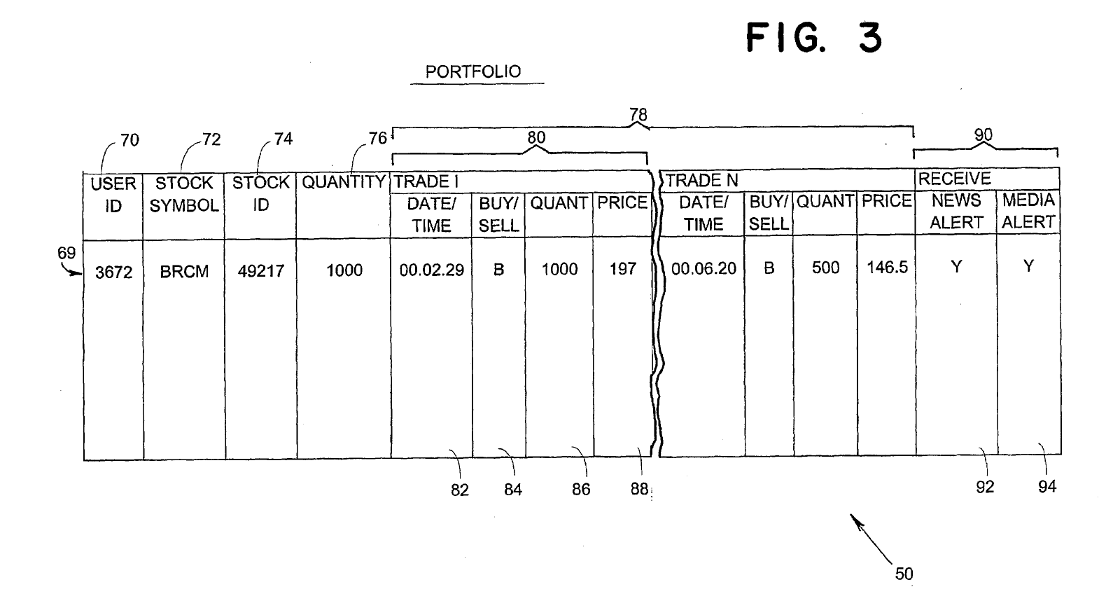

Referring to FIG. 3, the portfolio table is shown generally at 50. The portfolio table stores a plurality of portfolio records, one of which is shown at 69. Each portfolio record 69 includes a user ID field 70, a stock symbol field 72, a stock ID field 74, a quantity field 76, a transaction history field 78, and an alerts field 90.

The user ID field 70 contains the unique number that uniquely identifies each subscriber. Referring to FIGS. 2 and 3, the user ID field 58 in the subscriber information table 48 and the user ID field 70 in the portfolio table 50 are relationally linked within the subscriber database 38.

The stock symbol field 72 stores a string identifying an investment holding, which in this embodiment is a company stock, owned or specified by the subscriber. For example, the stock symbol field may store the string “BRCM”, identifying stock in Broadcom Corporation. The stock ID field 74 stores a unique number assigned by the processor circuit 32 to uniquely identify each stock. The quantity field 76 indicates a total quantity of the stock owned by, or indicated by, the subscriber.

In this embodiment, the transaction history field 78 is subdivided into a plurality of individual transaction fields, one of which is shown at 80. Each individual transaction field 80 corresponds to a separate individual transaction by the subscriber identified by the user ID field 70, in relation to the stock identified by the stock ID field 74. Each individual transaction field 80 is subdivided into a datestamp field 82 for storing an indication of the date of the transaction, a buy/sell field 84 for storing an indication of whether the transaction was a purchase or a sale, a quantity field 86 for storing a quantity of the stock that was bought or sold, and a price field 88 for storing a price per share at which the stock was bought or sold. If desired, the individual transaction field may include additional fields, such as a commission field (not shown) for storing an indication of a commission paid by the particular subscriber in relation to the transaction, for example.

The alerts field 90 is used to store an indication of whether the subscriber identified by the user ID field 70 wishes to receive news relating to the stock identified by the stock ID field 74. In this embodiment, the alerts field 90 is subdivided into a news alert field 92 for storing an indication of whether the subscriber wishes to receive press releases issued by the company that issued the stock, and a media alert field 94 for storing an indication of whether the subscriber wishes to receive articles written by the news media relating to the stock. Such releases may be automatically forwarded to the subscriber by e-mail, for example.

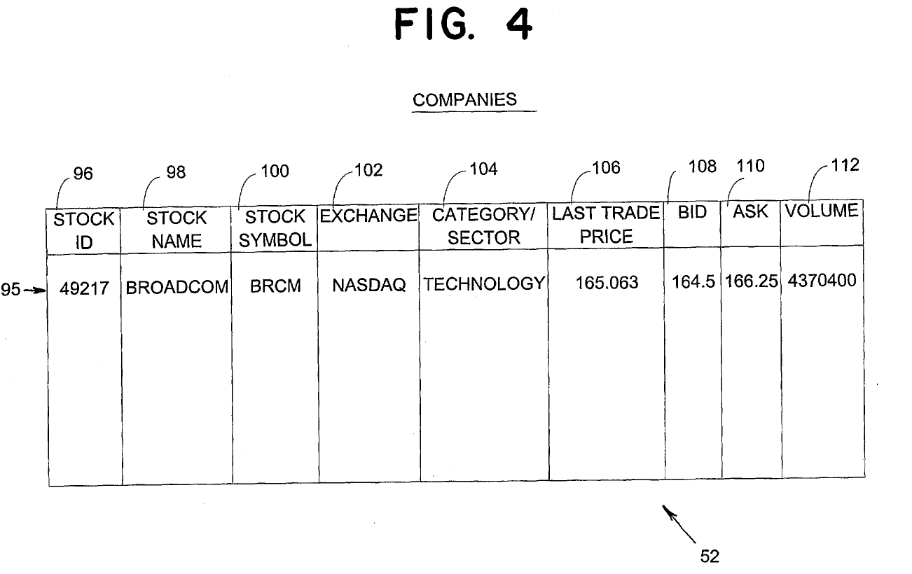

Referring to FIG. 4, the companies table is shown generally at 52. The companies table 52 stores a plurality of company records, one of which is shown at 95. Each company record 95 corresponds to an individual publicly traded stock, and is subdivided into a stock ID field 96, a stock name field 98, a stock symbol field 100, an exchange field 102, a category/sector field 104, a last trade price field 106, a bid field 108, an ask field 110, and a volume field 112.

The stock ID field 96 stores the unique number assigned by the processor circuit 32 to uniquely identify each stock. The stock name field 98 stores a string indicating the full name of the stock identified by the stock ID field 96, and the stock symbol field 100 stores the string identifying the investment holding. Referring to FIGS. 3 and 4, the stock ID field 96 and the stock symbol field 100 are relationally linked to the stock ID field 74 and the stock symbol field 72 of the portfolio table 50, within the subscriber database 38.

Referring again to FIG. 4, the exchange field 102 stores a string identifying the exchange on which the stock is traded, such as “NASDAQ” for example. The category/sector field 104 stores an indication of a category, which in this embodiment is an industry sector, to which the stock corresponds, such as “technology” or “mining”, for example.

The last trade price filed 106 stores a number representing the price at which the stock identified by the stock ID field 96 was most recently traded. The bid field 108 stores a number representing an average price of the most recent purchase bids for the stock, and the ask field 110 stores a number representing an average price of the most recent offers to sell the stock. The volume field 112 stores a number representing the volume of shares of the stock that were traded on the current trading day, or on the most recent trading day if the exchange is closed. Referring to FIGS. 1 and 4, the last trade price field 106, the bid field 108, the ask field 110 and the volume field 112 are updated in real time by the processor circuit 32, in response to communications between the processor circuit 32 and various stock exchange servers (not shown), via the network 40.

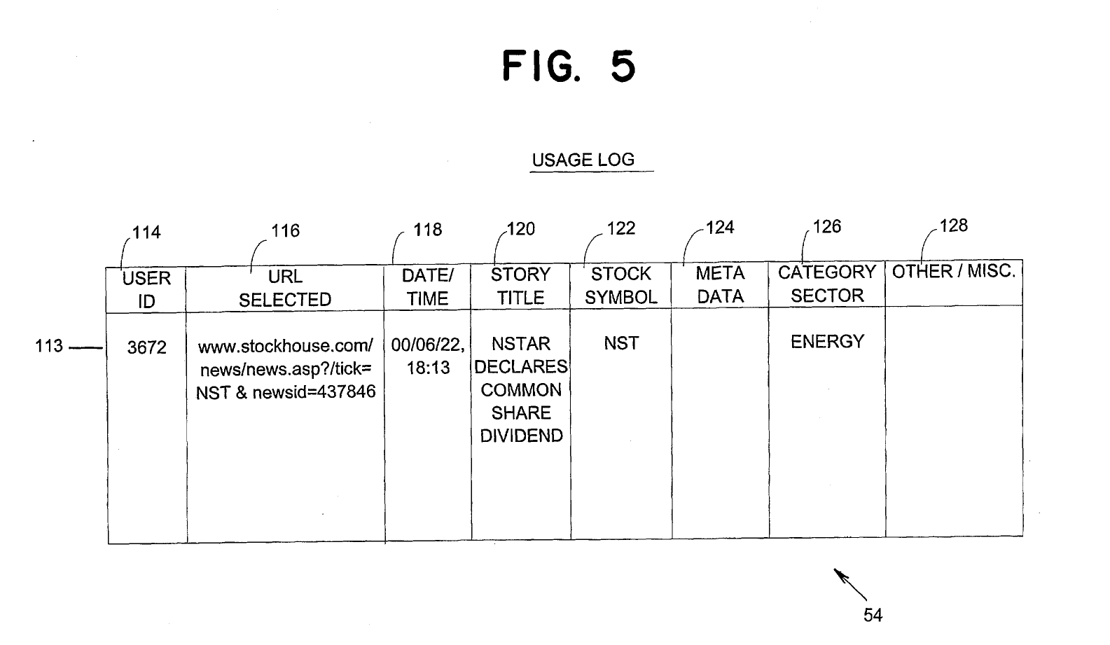

Referring to FIGS. 1 and 5, the usage log is shown generally at 54. The usage log 54 stores a plurality of usage records, one of which is shown at 113. Each usage record 113 corresponds to a monitored communication between a subscriber and a service, which in this embodiment is an informational web-site hosted by the server 34 shown in FIG. 1. Each usage record 113 includes a user ID field 114, a uniform resource locator (URL) field 116, a datestamp field 118, a title field 120, a stock symbol field 122, a meta data field 124, a category/sector field 126, and a miscellaneous field 128.

Referring to FIGS. 2 and 5, the user ID field 114 stores the unique number that uniquely identifies each subscriber. The user ID field 114 is relationally linked to the user ID field 58 of the subscriber information table 48 shown in FIG. 2.

Referring to FIG. 5, the URL field 116 stores a string identifying a uniform resource locator (sometimes referred to as a universal resource locator) selected by the subscriber to select a web page, and the datestamp field 118 stores numerical data representing the date and time at which the subscriber selected the URL.

The title field 120 stores a string representing a title or heading of information contained in the web page identified by the URL field 116. This may or may not be the same as the title of the web page itself.

The stock symbol field 122 stores a string representing a stock symbol of a stock to which the web page identified by the URL field 116 pertains or pertained. The meta data field 124 stores string data representing meta data contained in the source code of the web page identified by the URL field. The category/sector field 126 stores an indication of the category, or more particularly the industry sector, to which the contents of the web page identified by the URL field pertain or pertained. Referring to FIGS. 4 and 5, the stock symbol field 122 and the category/sector field 126 are relationally linked to the stock symbol field 100 and the category/sector field 104 of the companies table 52 shown in FIG. 4.

Content Database

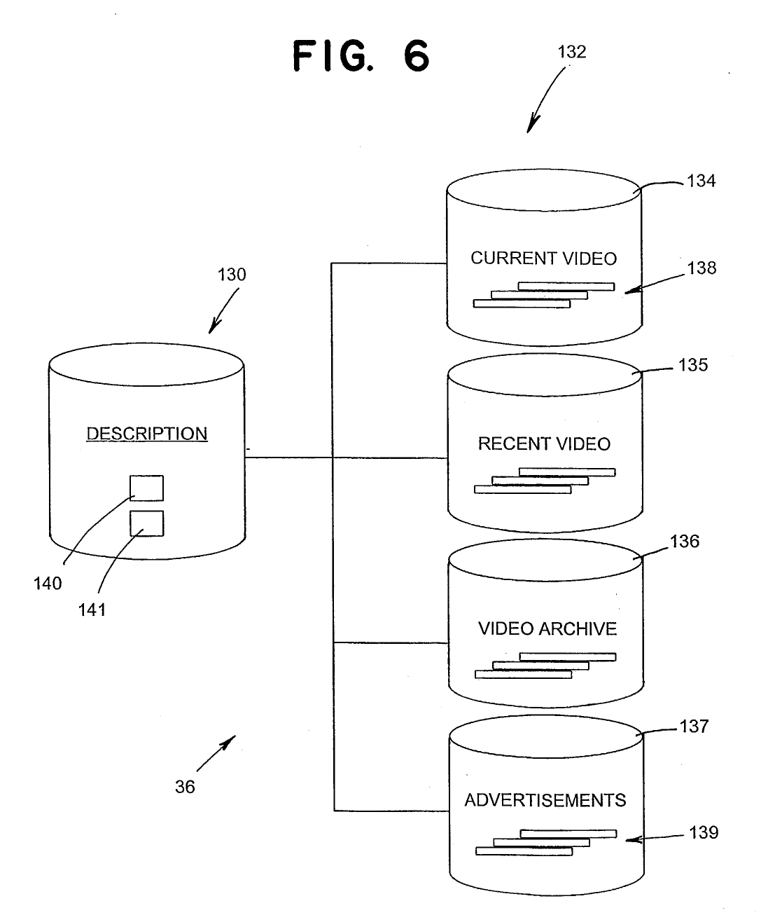

Referring to FIGS. 1 and 6, the content database 36 is in communication with the processor circuit 32, and stores the video segments having the smooth transition features. More particularly, in this embodiment the content database 36 includes a description database 130 and a video segment database 132. The description database 130 stores a content description table 140 containing information describing the content of a plurality of news video segments and an advertisement description table 141 describing the content of a plurality of advertisement video segments. The video segment database 132 stores the video segments.

In this embodiment, the description database 130 and the video segment database 132 are provided in separate storage media in communication with each other, and the video segment database includes a current video segment database 134 for storing video segments from the most recent week, a recent video segment database 135 for storing video segments between one week and two months old, a video segment archive database 136 for storing video segments older than two months, and an advertisements database 137 for storing advertisement video segments. Alternatively, however, the description database 130 and the video segment database 132 may be provided in a single storage medium, or may be provided in any combination of two or more storage media, any of which may be located either locally at or integral with the server 34 or remote from the server and in communication with the processor circuit 32 by any suitable communication method.

The video segment database 132 stores the video segments in respective video segment stores, such as those shown at 138 in FIG. 6. Similarly, advertisement video segments are stored in respective advertisement video segment stores, such as those shown at 139.

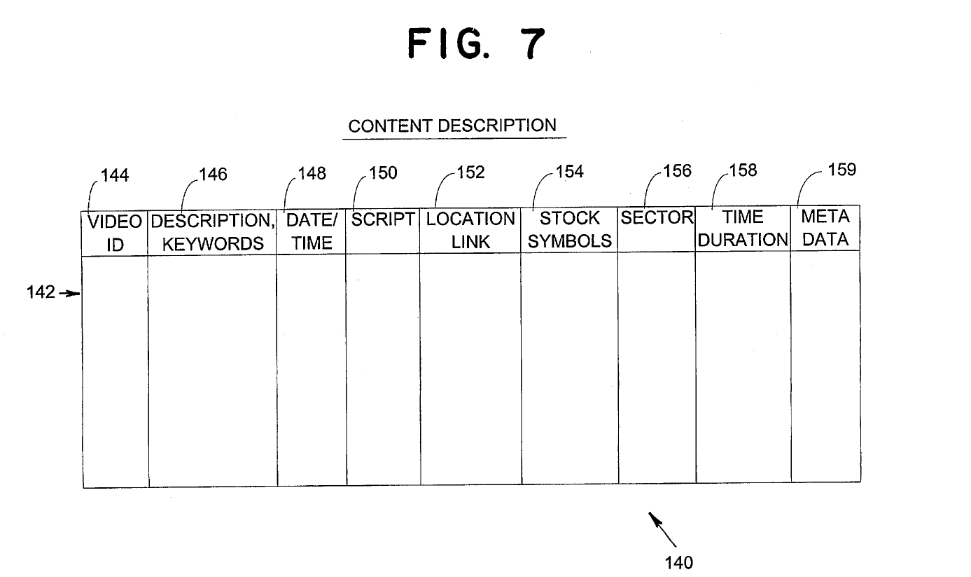

Referring to FIG. 7, the content description table is shown generally at 140. In this embodiment, the content description table includes a plurality of content description records, one of which is shown at 142. Each content description record 142 corresponds to a respective video segment, and includes a video ID field 144, a description field 146, a datestamp field 148, a script field 150, a link field 152, a stock symbol field 154, a category/sector field 156, a time duration field 158 and a meta data field 159.

The video ID field 144 stores a number uniquely identifying each video segment.

The description field 146 stores string data representing a description of the video segment. In this embodiment the description includes a title of the video segment and one or more semicolon-delimited keywords, however, other types of descriptions may be substituted.

The datestamp field 148 contains numerical data representing the date and time of production of the video segment.

The script field 150 stores string data representing a script of the video segment, as read by a narrator.

The link field 152 stores a link to the location at which the video segment is stored. In this embodiment the link field contains a link to a storage location of a particular video segment store 138 in the video segment database 132, however, alternatively the video segments may be stored elsewhere.

The stock symbol field 154 contains string data representing one or more stock symbols of company stocks to which the video segment pertains. Similarly, the category/sector field 156 contains string data representing a category, or more particularly an industry sector, to which the video segment pertains. It will be appreciated that some video segments may refer to an industry sector without referring to any specific company or stock, and thus the category/sector field 156 is not necessarily redundant. Referring to FIGS. 4 and 7, the stock symbol field 154 and the category/sector field 156 correspond to the stock symbol field 100 and the category/sector field 104 of the companies table 52 in the subscriber database.

Referring to FIG. 7, the time duration field 158 stores numerical data representing a playback duration of the video segment.

The meta data field 159 stores meta data associated with the video segment, as discussed in further detail below.

Referring to FIGS. 6 and 7, the advertisement description table 141 is similar in structure to the content description table 140.

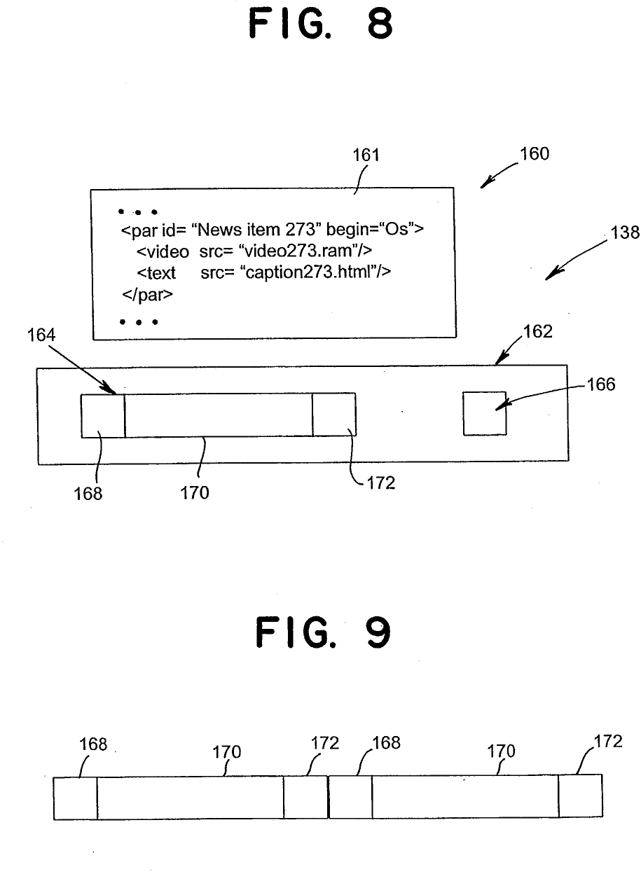

Referring to FIGS. 6 and 8, in this embodiment, each video segment stored in each respective video segment store 138 in the video segment database comprises a segment synchronization portion 160 and a segment content portion 162.

In this embodiment, the segment synchronization portion 160 includes a Synchronized Multimedia Integration Language (SMIL) file 161, and the segment content portion 162 includes a video file 164 containing both video and audio data, and also includes a caption file 166. More particularly, in this embodiment the caption file is a hypertext markup language (html) document and the video file is a RealVideo G2 file, however, other file types may be substituted.

Each SMIL file 161 may be executed to provide synchronized parallel and/or sequential presentation of various multimedia types in a single presentation. For example, the SMIL file 161 may provide for parallel presentation of the video file 164 and the caption file 166. Alternatively, the SMIL file 161 may be executed to provide synchronized execution of other combinations of video, audio, still image, text and other multimedia file types. Although such multimedia files have been described as stored in the segment content portion 162 in each video segment store 138, alternatively, such multimedia files may be located in any other location accessible by the processor circuit 32.

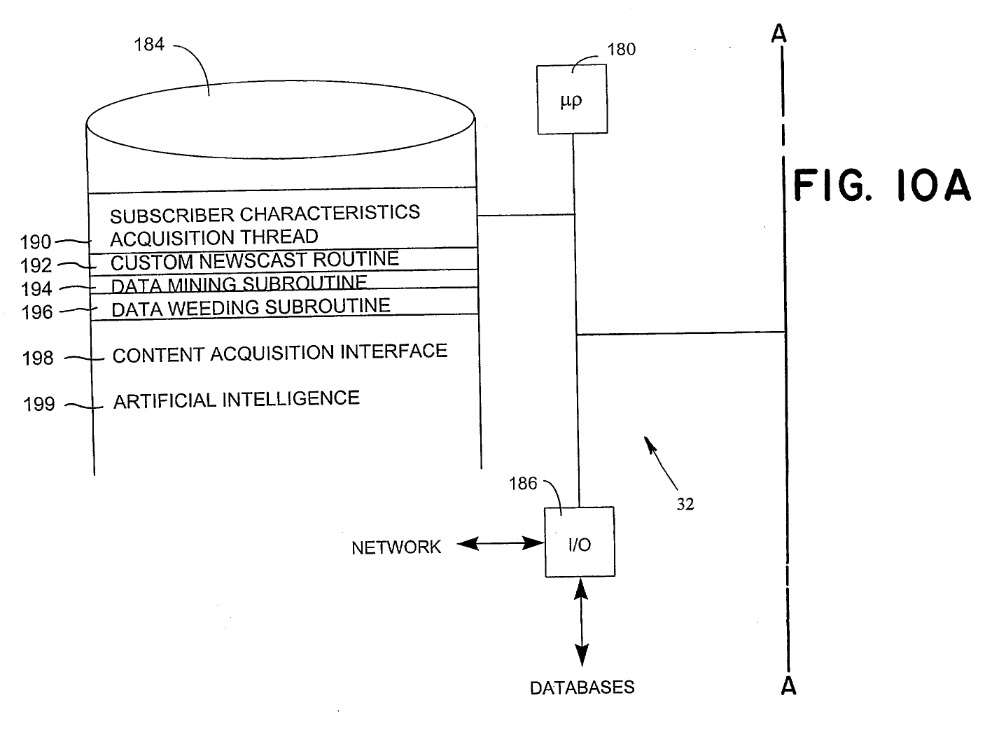

Referring to FIGS. 8 and 9, in this embodiment the video segments have smooth transition features, to prevent or reduce the occurrence of “jump cuts” when the video segments are played in succession. More particularly, the smooth transition features of the video segments include opening and closing scenes of the video segments sufficiently dissimilar from each other to prevent jump cuts from a closing scene of one video segment to an opening scene of a following video segment. For example, the video file 164 shown in FIG. 8 has an opening scene 168, scenes associated with the story shown generally at 170, and a closing scene 172 dissimilar from the opening scene 168.

In this embodiment, the opening scene 168 of the video segment typically includes a close-up view of a news anchor narrating an introduction to the video file 164. In conventional television newscasts, the closing scene is often also a close-up view of the news anchor making his or her closing comments in relation to the story. However, in the case of pre-recorded content, if the first and fourth news stories from such a conventional newscast were spliced together, removing the second and third stories, then the position of the anchor in the close-up view at the end of the first story would not precisely correspond to the anchor's position in the close-up view at the beginning of the fourth story, and therefore, a viewer viewing these two stories spliced together would view a disconcerting instantaneous movement of the news anchor on the screen, referred to herein as a “jump cut”. This is not a problem in live broadcasting because there are no problems with continuity.

Thus, in order to provide a smooth transition feature to prevent such a “jump cut” from occurring, the closing scene 172 may include any scene not similar to that presented in the opening scene 168. For example, the closing scene 172 may include a wide shot such as a wide angle view of the newsroom, a graphic such as a logo, a fade to black, a continuation of the story scenes 170, or a suitable “off camera” shot signifying the end of the video segment, or any other scene dissimilar from the opening scene 168. Thus, as shown in FIG. 9, when two such video files are presented in sequence, the closing scene 172 of the first video file, which may be a wide angle shot of the newsroom, for example, is dissimilar from the opening scene 168 of the next video file, which may be a close-up of the narrator, for example, and a jump cut will not be observed.

Alternatively, it will be appreciated that the opening scene 168 need not commence with a view of a narrator or anchor. For example, the opening scene 168 might include a title screen showing the title of the story, in which case the closing scene 172 could include a view of the narrator without resulting in a jump cut.

In addition, although it is preferable to include the smooth transition features of the video segment in the video file 164 itself, this is not strictly necessary. Alternatively, for example, the SMIL file 161 of the video segment could easily be used to schedule a suitable still or motion “bumper” image dissimilar to either the opening or closing scenes, such as a graphic or logo for example, either before each opening scene 168 or after each closing scene 172, for example.

These and many other ways of providing smooth transition features to prevent jump cuts would be apparent to one of ordinary skill in the art upon reviewing this specification, and are not considered to depart from the scope of the invention as construed in accordance with the accompanying claims.

Referring to FIGS. 6 and 8, in this embodiment, each advertisement video segment stored in each respective advertisement video segment store 139 in the video segment database 132 also includes a segment synchronization portion and a segment content portion, similar to those provided in the video segment stores 138 shown in FIG. 8. However, it will be appreciated that an advertisement is not likely to have either a starting or ending scene similar to a preceding or succeeding scene respectively, and therefore in this embodiment the advertisement video segments will usually automatically have smooth transition features, without the necessity of taking any particular steps to ensure such smooth transition features. Alternatively, such advertisement segments need not be provided in a SMIL format, and may simply be presented as still or motion video images, for example.

Processor Circuit

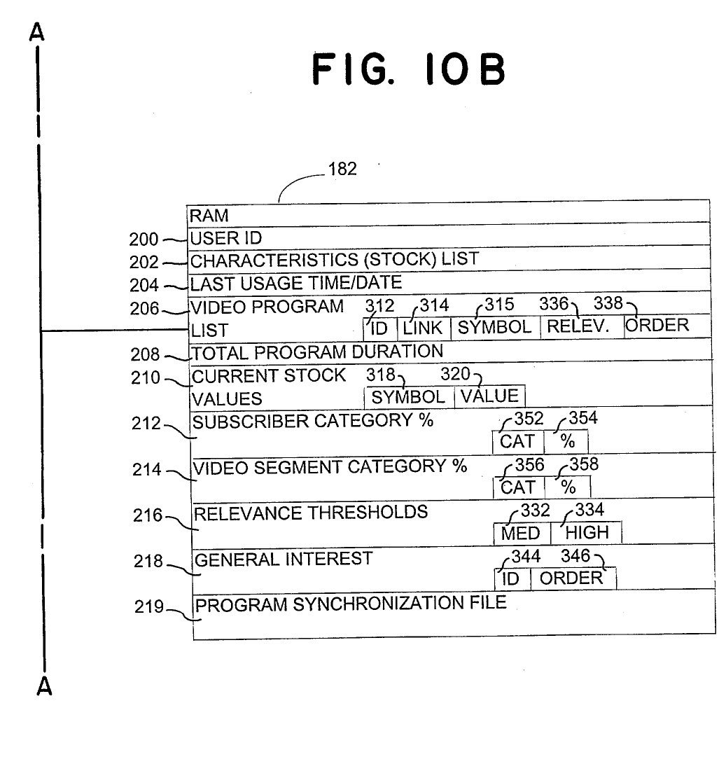

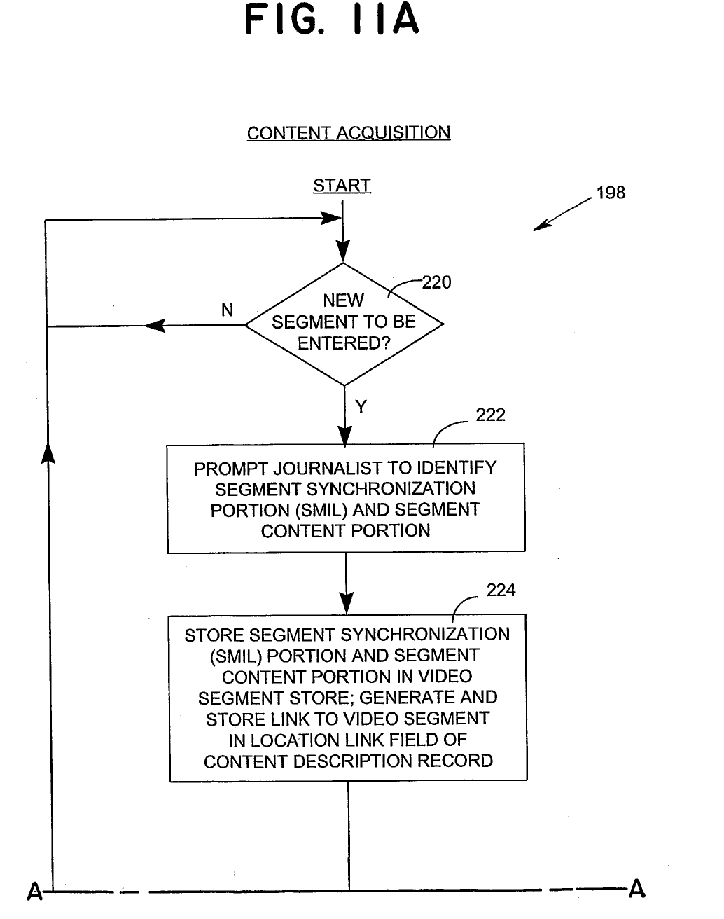

Referring to FIGS. 1 and 10A and 10B, the processor circuit is shown generally at 32 in FIGS. 10A and 10B. The processor circuit 32 includes a programmable device, which in this embodiment is a microprocessor 180 in communication with a random access memory (RAM) 182, a storage medium 184 and an input/output (I/O) unit 186, via a data bus 188.

Alternatively, the processor circuit 32 may include any programmable device or any circuit or combination of circuits capable of performing the functions described herein. Alternatively, therefore, the processor circuit 32 need not be implemented in the server 34, and may include a combination of one or more microprocessors, microcontrollers, other integrated circuits, or logic gate arrays, either at the same location or remote from each other, for example. Other such variations will be appreciated by one of ordinary skill in the art upon reading this specification and are not considered to depart from the scope of the present invention as construed in accordance with the accompanying claims.

The storage medium 184 is used to store program codes for directing the processor circuit 32 to execute a plurality of routines, including a subscriber characteristics acquisition thread 190, a custom newscast routine 192, a data mining subroutine 194, a data weeding subroutine 196, and a content acquisition interface thread 198. In this embodiment, the storage medium 184 is a hard disk drive. However, the hard disk drive is merely one example of a computer readable medium for providing instructions for directing a programmable device to perform the above routines. Alternatively, such routines may be implemented entirely through execution of software stored on other computer readable media such as a compact disc or on a floppy diskette, or a separate permanent memory (not shown), for example. Generally, any alternative methods or structures for generating a signal embodied in a carrier wave comprising code segments for directing a processor circuit to perform equivalent functions to those described herein are not considered to depart from the scope of the present invention as construed in accordance with the accompanying claims.

The subscriber characteristics acquisition thread 190 configures the processor circuit 32 to acquire subscriber characteristics relating to the various subscribers 42 shown in FIG. 1, and to store such subscriber characteristics in the subscriber database 38.

The custom newscast routine 192 configures the processor circuit 32 to present customized multimedia to any particular one of the subscribers 42, by causing video segments having information content associated with the particular subscriber and having smooth transition features, to be successively played to produce a continuous video program including the segments.

The data mining subroutine 194 and the data weeding subroutine 196 configure the processor circuit 32 to optimize the continuous video program.

More particularly, in this embodiment the data mining subroutine 194 configures the processor circuit 32 to identify additional video segments in the content database 36 having information content associated with the particular subscriber, when the playback duration of the continuous video program is less than the desired playback duration.

In the preferred embodiment the data weeding subroutine 196 configures the processor circuit 32 to eliminate a video segment identified as having information content associated with the particular subscriber, when the playback duration of the continuous video program exceeds the desired playback duration.

The content acquisition interface thread 198 configures the processor circuit 32 to communicate with a journalist or other content worker to acquire and store a video segment and its description in the video segment database 132 and the description database 130 respectively.

The above routines configure the processor circuit 32 to define in the RAM 182 a plurality of registers, including a user ID register 200, a characteristics list register 202, a last usage time/date register 204, a video program list register 206, a total program duration register 208, a current stock values register 210, a subscriber category percentage (SUB-CAT %) register 212, a video segment category percentage (VID-CAT %) register 214, a relevance thresholds register 216, a general interest register 218, and a program synchronization file register 219.

The user ID register 200 temporarily stores the unique user ID of a particular subscriber 44, for use by the processor circuit 32 in identifying customized multimedia content associated with the particular subscriber.

The characteristics list register 202 temporarily stores a list of subscriber characteristics associated with the particular subscriber 44 identified by the user ID register 200. In this embodiment, the subscriber characteristics stored in the characteristics list register 202 include identifications of stocks owned by or otherwise associated with the subscriber.

The last usage time/date register 204 stores an indication of a time and date of a most recent communication between the particular subscriber 44 and the processor circuit 32.

The video program list register 206 stores identifications of video segments selected by the processor circuit 32 to be included in the customized continuous video program of video segments associated with the particular subscriber 44.

The total program duration register 208 stores a number representing the total time duration of the continuous video program comprising the video segments identified in the video program list register 206.

The current stock values register 210 stores indications of current dynamic values associated with subscriber characteristics, or more particularly, current dollar values associated with stocks listed in the characteristics list register 202.

The SUB-CAT % register 212 stores a plurality of values representing the percentage of subscriber characteristics of a particular subscriber that are associated with each of a plurality of characteristic categories.

Similarly, the VID-CAT % register 214 stores a plurality of values, each value representing the percentage of video segments identified in the video program list register 206 that correspond to a particular characteristic category. In the present embodiment, each such value represents a percentage of the duration of the video program that corresponds to the particular characteristic category.

The relevance thresholds register 216 stores a number of relevance threshold values used by the processor circuit 32 in determining a degree of relevance of a video segment to a particular subscriber.

The general interest register 218 stores identifications of general interest video segments identified as being of interest to all subscribers 42.

The program synchronization file register 219 stores a synchronization file for use by the processor circuit in causing the video segments to be played in the continuous video program.

Operation

Content Acquisition Interface Thread

Referring back to FIGS. 1, 6, 7, 8 and 10A and 10B, the content acquisition interface thread 198 shown in FIGS. 10A and 10B configures the processor circuit 32 to communicate with a news journalist or other news content worker (not shown) to load a video segment and its description into the video segment database 132 and the description database 130 respectively of the content database 36. The journalist may be located at the location of the server 34, or alternatively, may be located anywhere in the world and in communication with the processor circuit 32 via the network 40.

The journalist first researches and writes the script for the story. The journalist then orders and obtains any existing multimedia content, such as graphics or video footage for example, required to complement the story. A recording technician then records additional multimedia content, such as video of a news anchor narrating the story, for example. Alternatively, if motion video footage is available, the additional recorded content might include only audio narration, if desired. In any event, the combination of the above multimedia content is produced so as to include smooth transition features, as described above. The recorded multimedia content is temporarily stored on an editing server (not shown). In the present embodiment, the multimedia content stored on the editing server is compressed and encoded into a suitable format, such as a Windows Media format or a RealVideo G2 format for example, prior to its storage in the content database 36.

The journalist or other worker may then create the SMIL file 161 shown in FIG. 8, to synchronize the presentation of any video, audio, graphics, text or other multimedia selected by the journalist to form part of the video segment. In this regard, it will be appreciated that journalists do not necessarily have any programming ability, and therefore, suitable user-friendly SMIL authoring software, such as the SMIL Composer SuperTool available from Sausage Software of Melbourne, Australia for example, may be used to create the SMIL file using a user-friendly graphical interface. If desired, the journalist may also use the SMIL authoring software to enter keywords or other search terms as meta tags or other meta data into the SMIL file 161.

An SMIL file is created for each video file. Many SMIL authorizing tools are available. SMIL Composer SuperTool is currently the best tool which is free.

The journalist or other content worker then communicates with the server 34 over the network 40 using a browser (not shown) for example.

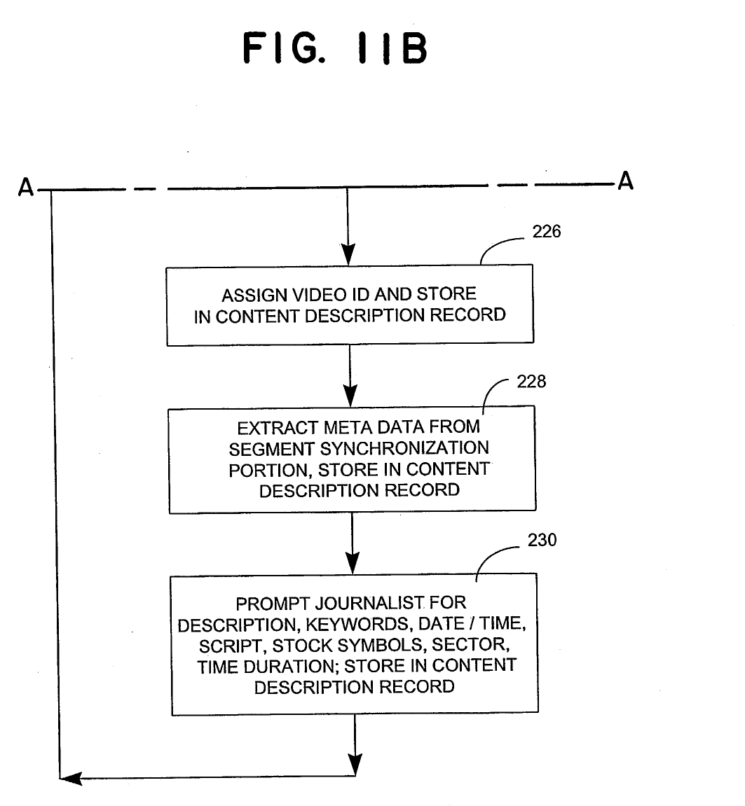

Referring to FIGS. 6, 7, 8, 10A, 10B, 11A and 11B, the content acquisition interface thread is shown in greater detail at 198 in FIGS. 1A and 11B. The content acquisition interface thread begins with a first block of codes 220 that directs the processor circuit 32 to await receipt of a communication from a journalist indicating that a new video segment is to be added to the content database 36.

Upon receiving such a communication at block 220, block 222 directs the processor circuit 32 to prompt the journalist to communicate an identification of the segment synchronization portion 160 and the segment content portion 162 of the video segment that is to be added. More particularly, block 222 directs the processor circuit to transmit a hypertext markup language (HTML) page to the journalist to provide a graphical user interface prompting the journalist to use a menu (not shown) to browse for and identify the local file locations on the journalist's editing server (not shown) of the segment synchronization portion 160 and the segment content portion 162.

Upon receiving the file locations in response to the prompt produced at block 222, block 224 directs the processor circuit 32 to retrieve and store the segment synchronization portion 160, which in this embodiment is the SMIL file 161 shown in FIG. 8, and the segment content portion 162, in a new video segment store 138 in the video segment database 132. Block 224 further directs the processor circuit 32 to generate a new content description record 142 in the content description database 130 shown in FIGS. 6 and 7. Block 224 then directs the processor circuit to generate a link to the location in the video segment database 132 of the new video segment store 138, and to store the link in the location link field 152 of the new content description record 142.

Block 226 then directs the processor circuit 32 to assign a unique number to uniquely identify the new video segment, and to store this number in the video ID field 144 of the new content description record 142.

Block 228 directs the processor circuit 32 to examine the contents of the segment synchronization portion 160, which in this embodiment is the SMIL file 161, of the new video segment. Block 228 directs the processor circuit to copy the meta data, if any, stored in the SMIL file 161, into the meta data field 159 of the new content description record 142 shown in FIG. 7.

Block 230 then directs the processor circuit 32 to prompt the journalist for additional data relating to the new video segment, such as a title of the video segment and keywords, a time and date of the video segment, the script corresponding to the video segment, stock symbols of stocks referred to in the video segment, an industry sector to which the video segment relates (which may be useful if no particular stocks are referred to in the segment), and a time duration of the video segment. More particularly, block 230 directs the processor circuit to transmit an HTML page (not shown) to the journalist, the HTML page containing fields and text prompting the journalist to enter the information into the fields, and a “submit” button to transmit the entered information back to the processor circuit. Upon receiving the above information, block 230 directs the processor circuit to store the title and keywords as semicolon delimited string data in the description field 146 of the new content description record 142, and to store the time and date information, the script, the stock symbols, the industry sector and the time duration in the appropriate fields 148, 150, 154, 156 and 158 of the new content description record 142.

Alternatively, the journalist may enter all relevant information as meta data in the SMIL file 161. In this case, rather than prompting the journalist to re-enter such information, a modified block 230 directs the processor circuit to extract all such meta data from the SMIL file 161 and to store the meta data in the fields 146, 148, 150, 154, 156 or 158, as appropriate. More generally, a myriad of alternative ways of obtaining and storing multimedia content information such as video segments would be apparent to one of ordinary skill in the art upon reviewing this specification. Any such alternatives are not considered to depart from the scope of the invention as construed in accordance with the accompanying claims.

Subscriber Characteristics Acquisition Thread

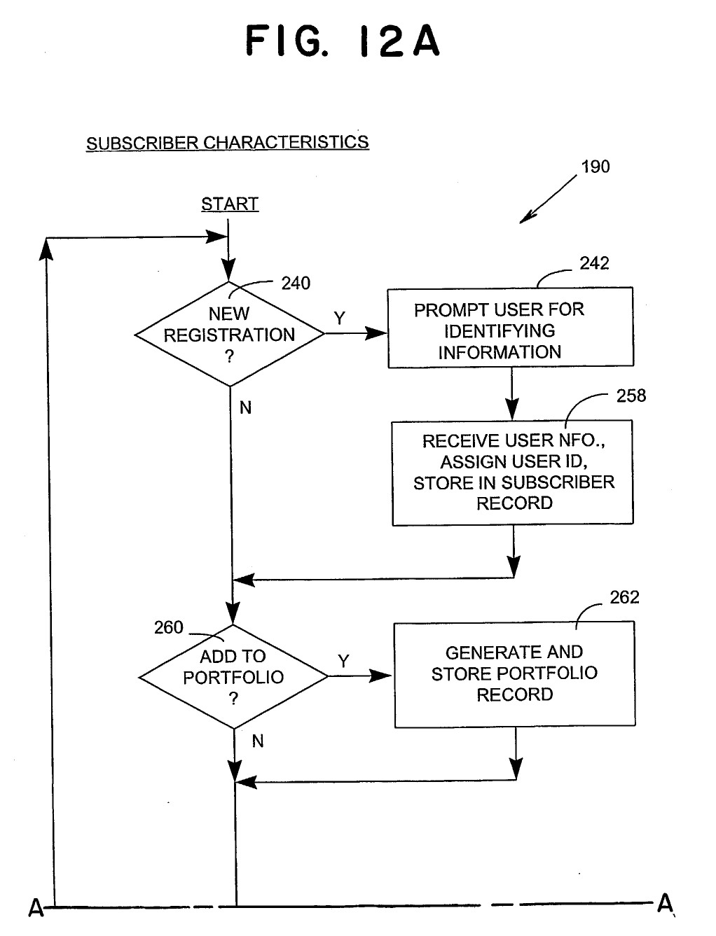

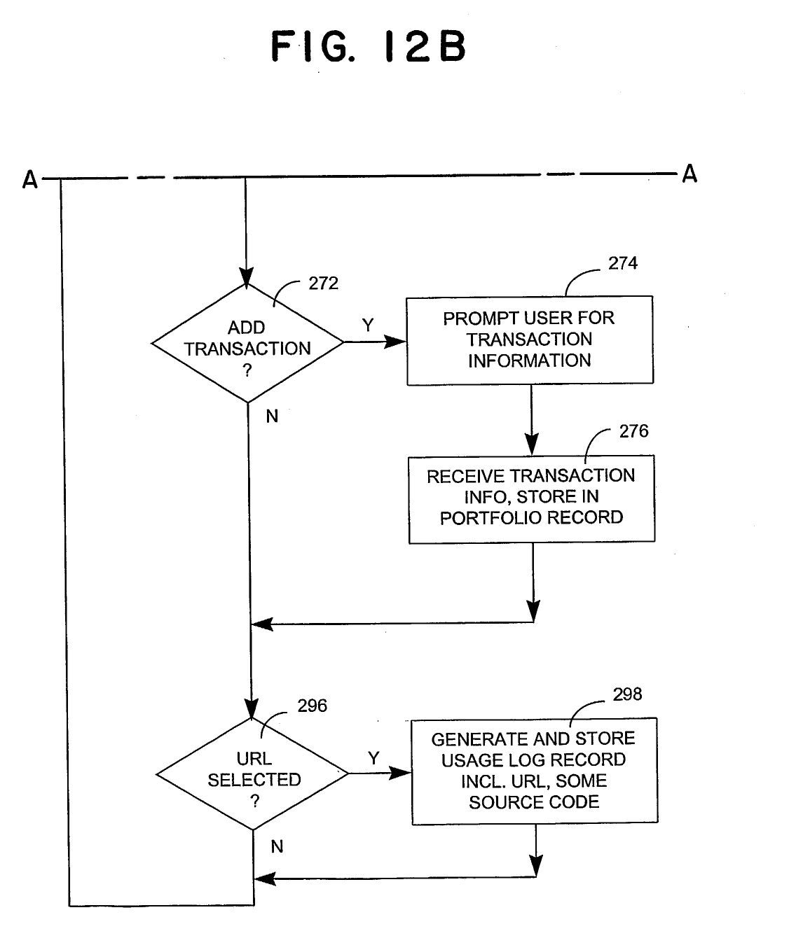

Referring to FIGS. 1, 10A, 10B, 12A and 12B, the subscriber characteristics acquisition thread is shown in greater detail at 190 in FIGS. 12A and 12B. Generally, the subscriber characteristics acquisition thread configures the processor circuit 32 to store in the subscriber database 38 at least one subscriber characteristic associated with each particular subscriber 44 of the plurality of subscribers 42 shown in FIG. 1. More particularly, in this embodiment, the subscriber characteristics acquisition thread configures the process circuit to acquire at least some of the subscriber characteristics from the subscribers, as described below.

The subscriber characteristics acquisition thread 190 begins with a first block of codes 240 shown in FIGS. 12A and 12B, which directs the processor circuit 32 to determine whether a signal has been received over the network 40 indicating a request for registration by a new subscriber.

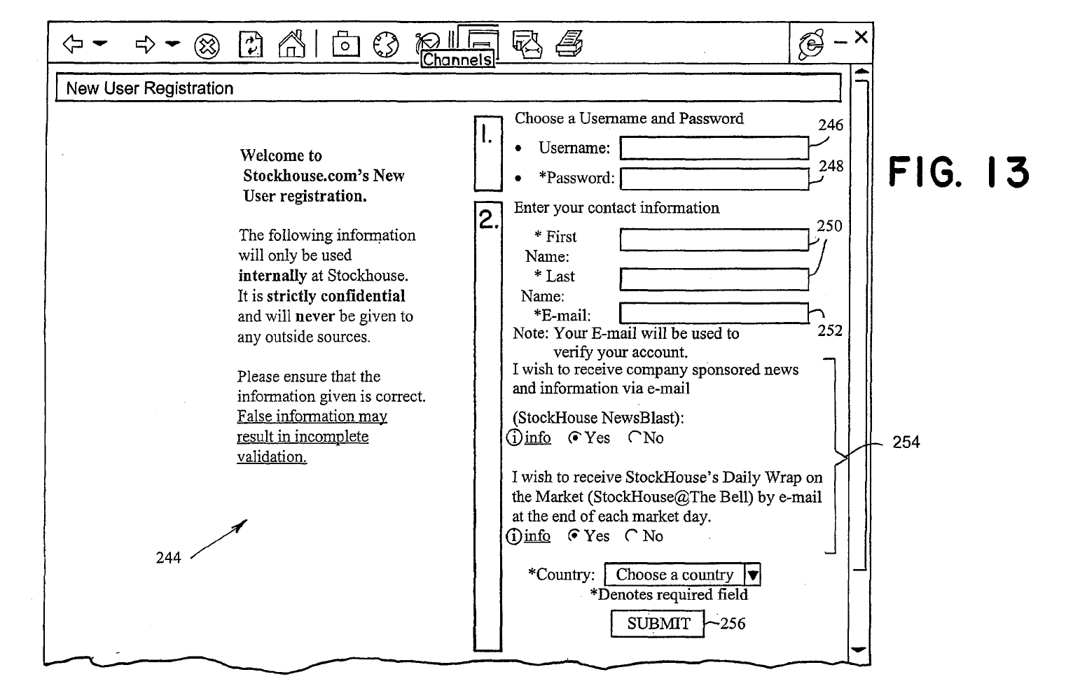

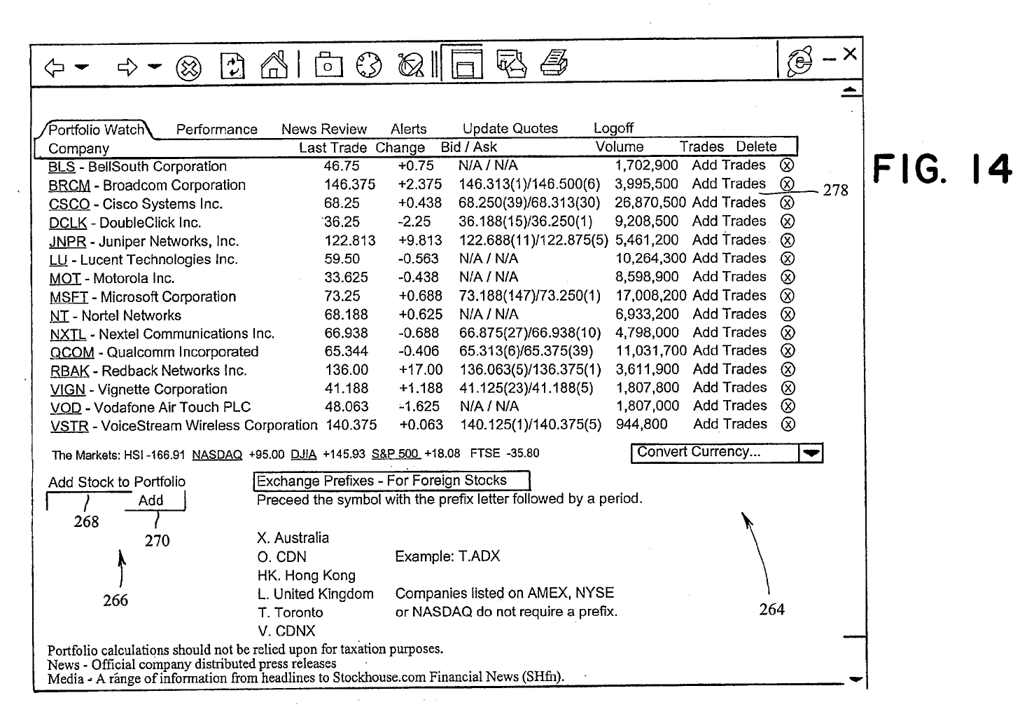

Referring to FIGS. 12A, 12B and 13, if such a signal is detected at block 240, block 242 directs the processor circuit 32 to prompt the new subscriber to communicate subscriber characteristics to the processor circuit. More particularly, in this embodiment, block 242 directs the processor circuit to transmit an HTML page such as that shown at 244 in FIG. 13, over the network 40 to the new subscriber. The HTML page 244 provides a graphical user interface prompting the new subscriber to enter subscriber characteristics in a plurality of characteristic fields, such as a username field 246 and a password field 248 for entry of an on-line username and password, one or more name fields 250 for entry of the new subscriber's full name, an email address field 252 for entry of the new subscriber's e-mail address, and a general alerts field 254 providing an option for the new subscriber to receive general news alerts, for example. Alternatively, block 242 may direct the processor circuit to prompt the new subscriber for other subscriber characteristics, either in addition to or instead of those shown in FIG. 13. The new subscriber may transmit such subscriber characteristics to the processor circuit by actuating a “submit” button 256 provided in the HTML page 244, for example.

Referring to FIGS. 2, 12A, 12B and 13, block 258 then directs the processor circuit 32 to await receipt of the subscriber characteristics prompted at block 242, and upon acquiring or receiving such subscriber characteristics, block 258 directs the processor circuit to generate a new subscriber information record 55 in the subscriber information table 48 shown in FIG. 2, and to store the acquired subscriber characteristics in the new subscriber information record 55. More particularly, in this embodiment, upon receiving the contents of the form fields 246 to 254 of the HTML page 244 from the new subscriber, block 258 directs the processor circuit to store the received contents of the username field 246 and password field 248 in the username field 56 and the password field 57 of the new subscriber information record 55. Similarly, block 258 directs the processor circuit to store the contents of the name fields 250, the e-mail address field 252 and the general alerts field 254 in the full name field 60, the e-mail field 66 and the receive general alerts field 68 of the subscriber information record 55 respectively. Block 258 further directs the processor circuit 32 to generate a unique number to uniquely identify the new subscriber, and to store this number in the user ID field 58 of the new subscriber information record 55.

Referring to FIGS. 1, 3, 12A, 12B and 14, blocks 260 and 262 then configure the processor circuit 32 to store, as the at least one subscriber characteristic, an identification of an investment holding of the particular subscriber.

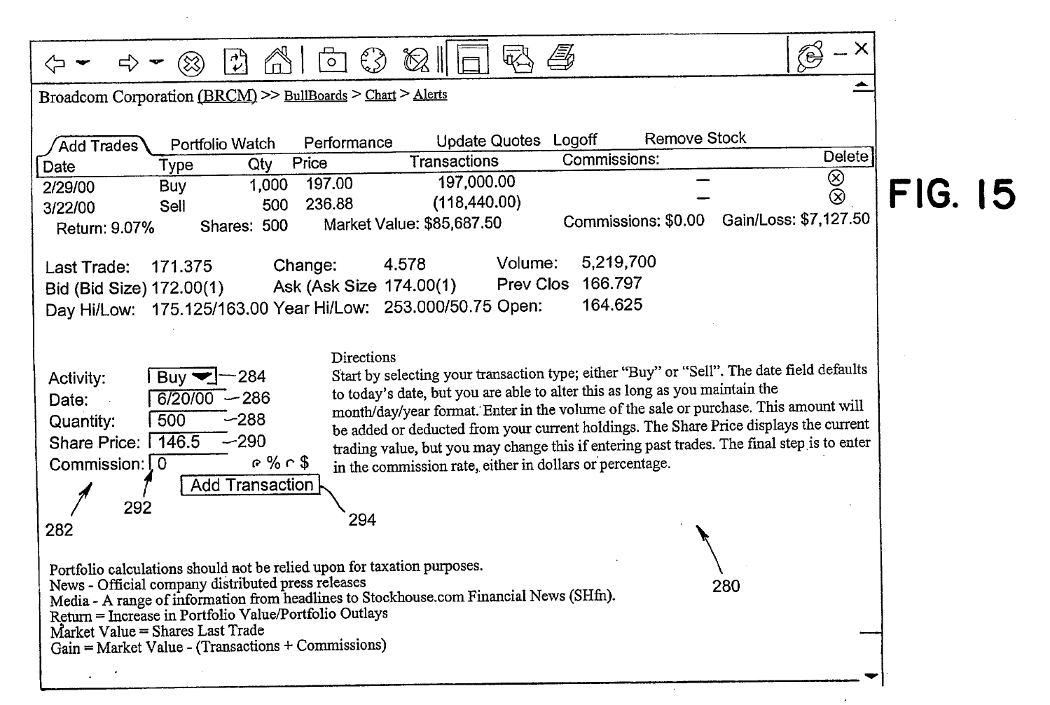

More particularly, following execution of blocks 242 and 258, or alternatively if no new registration signal is detected at block 240, the processor circuit 32 is directed at block 260 to determine whether a signal has been received from one of the plurality of subscribers 42 indicating that a new stock is to be added to the subscriber's portfolio. For example, when the particular subscriber 44 has logged onto and is browsing a web-site provided by the server 34 shown in FIG. 1, the particular subscriber may be presented with an HTML page such as that shown at 264 in FIG. 14, describing the particular subscriber's current portfolio, and providing an entry field such as that shown at 266, allowing the particular subscriber to enter a subscriber characteristic, or more particularly, an identification of a stock that is to be added to the particular subscriber's portfolio. In the present embodiment, the particular subscriber 44 may enter an identification of the stock, such as a stock symbol, into a subscriber characteristic entry field 268 of the HTML page 264, and may then actuate an “add” button 270 to transmit the contents of the subscriber characteristic entry field to the processor circuit 32 over the network 40.

Referring to FIGS. 3, 4, 12A and 12B, upon receiving such a transmitted stock symbol (or other subscriber characteristic) at block 260, block 262 directs the processor circuit 32 to generate a new portfolio record 69 corresponding to the stock to be added, such as the portfolio record 69 shown in FIG. 3. Block 262 directs the processor circuit to store the unique user ID of the particular subscriber 44 who transmitted the stock symbol, in the user ID field 70 of the new portfolio record 69. This user ID number is identical to the contents of the user ID field 58 of the subscriber information record 55 corresponding to the particular subscriber 4.4. In this regard, tracking of the user ID of the particular subscriber 44 following login may be achieved in a conventional manner and need not be described further herein. In this embodiment, block 262 further directs the processor circuit to store the stock symbol transmitted by the subscriber in the stock symbol field 72 of the new portfolio record 69. Block 262 also directs the processor circuit to search the companies table 52 shown in FIG. 4, for a company record 95 having a stock symbol field 100 whose contents correspond to the contents of the stock symbol field 72 of the new portfolio record 69. Upon locating such a company record 95, block 262 directs the processor circuit to copy the contents of the stock ID field 96 of the company record 95 into the stock ID field 74 of the portfolio record 69.

Referring to FIGS. 1, 3, 12A, 12B, 14 and 15, blocks 272, 274 and 276 then configure the processor circuit 32 to store, as the at least one subscriber characteristic, an identification of at least one transaction made by the particular subscriber 44 relating to an investment holding.

Following execution of blocks 260 and 262, or alternatively if no new stock signal is detected at block 260, the processor circuit 32 is then directed at block 272 to determine whether a signal has been received from one of the plurality of subscribers 42 indicating that a new transaction is to be added to the subscriber's portfolio. For example, when the particular subscriber 44 is browsing the HTML page 264 shown in FIG. 14 representing the particular subscriber's current portfolio, the subscriber may be presented with an “add trades” button 278 corresponding to each stock in the particular subscriber's portfolio. When the particular subscriber 44 actuates one of the “add trades” buttons 278, a signal requesting addition of a transaction relating to the corresponding stock in the subscriber's portfolio is transmitted to the processor circuit 32.

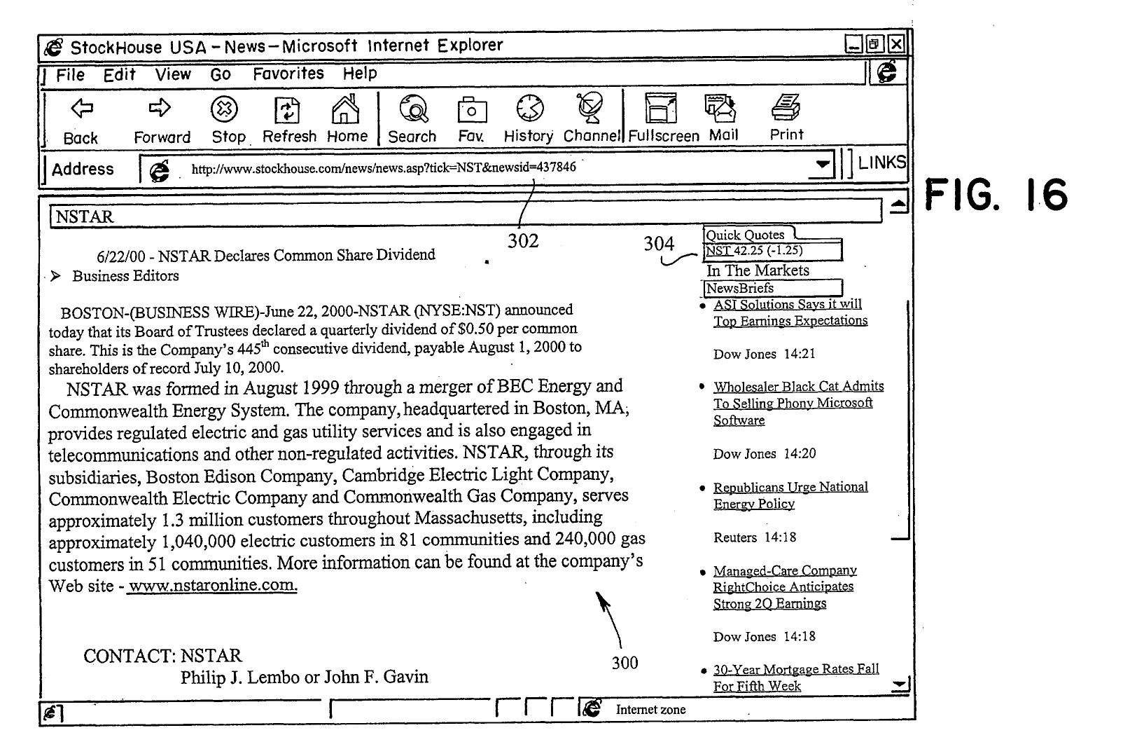

Upon receiving such a signal at block 272, block 274 directs the processor circuit 32 to prompt the particular subscriber 44 to enter further subscriber characteristics, or more particularly, information relating to the subscriber's transaction. To achieve this, block 274 directs the processor circuit 32 to transmit to the particular subscriber 44 an HTML page such as that shown at 280 in FIG. 15. The HTML page 280 includes a subscriber characteristic entry interface 282, which in this embodiment includes a buy/sell field 284 for entry of an indication of whether the particular subscriber 44 has bought or sold the stock identified in the HTML page 280, a date field 286 for entry of the date of the share purchase or sale, a quantity field 288 for entry of a number of shares bought or sold by the particular subscriber 44, and a share price field 290 for entry of a price per share of the transaction. If desired, the subscriber characteristic entry interface 282 may also include a commission field 292. When the particular subscriber 44 has entered such information, the subscriber actuates an “add transaction” button 294 in the HTML page 280 to transmit the contents of the subscriber characteristic entry interface 282 to the processor circuit 32.

Upon receiving such subscriber characteristics, block 276 directs the processor circuit 32 to locate, in the portfolio table 50 shown in FIG. 3, a portfolio record 69 whose user ID field 70 contents and stock ID field 74 contents correspond to the particular subscriber 44 and the stock to which the transaction and the HTML page 280 relate. Upon locating the correct portfolio record 69, block 276 directs the processor circuit to locate the next available individual transaction field 80 in the transaction history field 78 of the portfolio record 69. Block 276 then directs the processor circuit to store the contents of the buy/sell field 284, the date field 286, the quantity field 288 and the share price field 290 shown in FIG. 15, in the buy/sell field 84, the datestamp field 82, the quantity field 86 and the price field 88 respectively of the next available individual transaction field 80. Block 276 further directs the processor circuit 32 to calculate a net sum of all quantity fields 86 by adding the contents of all quantity fields 86 of individual transaction fields 80 having a “buy” indication in the buy/sell field 84, and by subtracting the contents of all quantity fields of individual transaction fields having a “sell” indication. Block 276 directs the processor circuit to store this net sum in the quantity field 76 of the portfolio record 69, overwriting the existing contents, if any, of the quantity field 76.

Referring to FIGS. 1, 5, 12A, 12B and 16, blocks 296 and 298 configure the processor circuit 32 to monitor communications between the particular subscriber 44 and a service, and to produce and store, as the at least one subscriber characteristic, a usage log of usage of the service by the particular subscriber. In this embodiment, the service is the informational web-site maintained by the server 34 shown in FIG. 1. Alternatively, however, communications between the particular subscriber 44 and other services may be monitored.

Block 296 directs the processor circuit 32 to determine whether a signal representing a Uniform Resource Locator (URL) has been received from one of the subscribers 42, indicating selection of a resource such as a web-page for viewing by the subscriber, for example.

Upon detecting such a signal, block 298 directs the processor circuit 32 to record, in the usage log 54 shown in FIG. 5, the uniform resource locator specified by the particular subscriber 44. More particularly, after transmitting the resource identified by the URL to the particular subscriber 44 who transmitted the URL to the processor circuit, block 298 further directs the processor circuit to generate a new usage record 113 in the usage log 54. The processor circuit is directed to store, in the user ID field 114 of the new usage record 113, the unique user ID number corresponding to the particular subscriber 44 who selected the URL. This user ID number is identical to the contents of the user ID field 58 of the subscriber information record 55 corresponding to the particular subscriber 44. In this regard, tracking of the user ID of the particular subscriber 44 following login may be achieved in a conventional manner and need not be described further herein. Block 298 further directs the processor circuit to store the URL transmitted by the particular subscriber 44, in the URL field 116 of the new usage record 113. Block 298 also directs the processor circuit to store, in the datestamp field 118, the date and time at which the particular subscriber 44 transmitted the URL to the processor circuit 32.

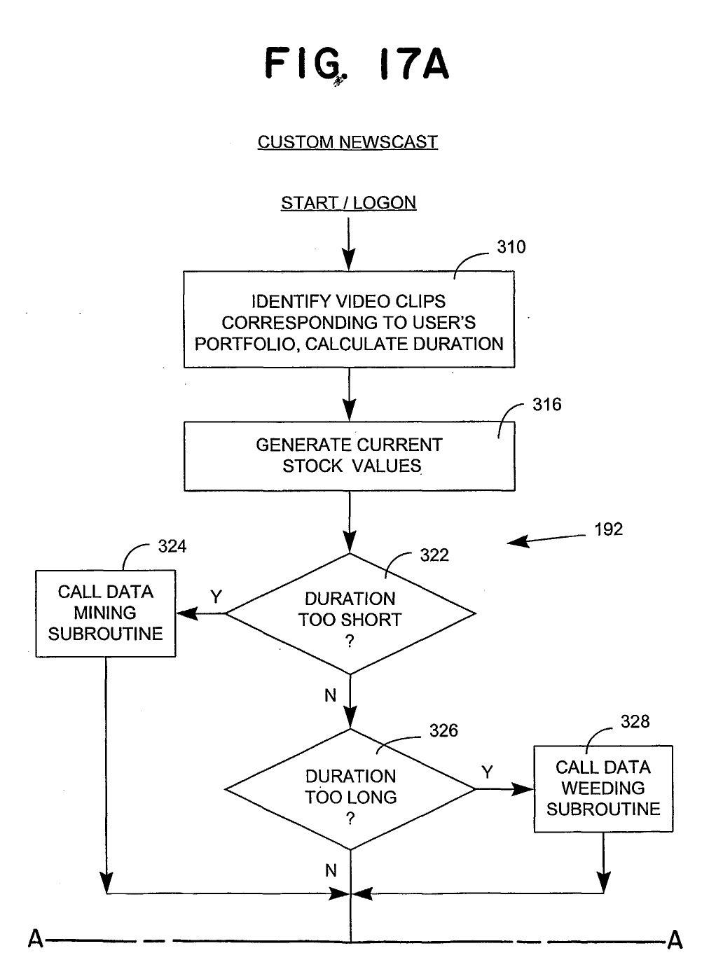

Referring to FIGS. 5, 12A, 12B and 16, block 298 additionally configures the processor circuit 32 to record in the usage log 54 at least some source code associated with the resource identified by the uniform resource locator specified by the particular subscriber 44. For example, where the resource is a web page such as that shown generally at 300 in FIG. 16, transmitted to the particular subscriber 44 in response to selection of a URL 302, block 298 directs the processor circuit to examine the HTML source code of the web page 300. In this embodiment, block 298 directs the processor circuit to locate a portion of the source code corresponding to the title of the story, such as “<td><b>NSTAR Declares Common Share Dividend </b></td>” for example, and to extract the title “NSTAR Declares Common Share Dividend” from such source code and copy it into the title field 120 of the usage record 113.

In addition, or alternatively, block 298 may further direct the processor circuit to store other source code extracts in the usage record 113. For example, in the present embodiment block 298 directs the processor circuit 32 to locate source code corresponding to a hyperlink 304 to further information about the company described in the web page 300, such as “<td><a href=“http://www.stockhouse.com/comp_info.asp?symbol=NST”><font size-1 face=arial><b>NST</b></font></a></td>” for example, and to extract the stock symbol NST from such source code and store it in the stock symbol field 122 of the usage record 113. Also in the present embodiment, block 298 further directs the processor circuit 32 to locate meta data in the source code of the web page 300, such as <META name=“keywords” CONTENT=“NSTAR, NST, dividend, common share, BEC Energy, Commonwealth Energy System, Boston Edison Company, Cambridge Electric Light Company, Commonwealth Electric Company, Commonwealth Gas Company”>”, for example, and to extract such keywords from the meta data and store the keywords in the meta data field 124 of the usage record 113. Similarly, if additional meta data or other source code are provided relating to the industry sector or other category to which the web page 300 pertains, or to other desirable information, block 298 may further direct the processor circuit to extract such information from the source code and to store such information in additional fields, such as the category/sector field 126 and the miscellaneous field 128 of the usage record 113, for example.

Custom Newscast Routine

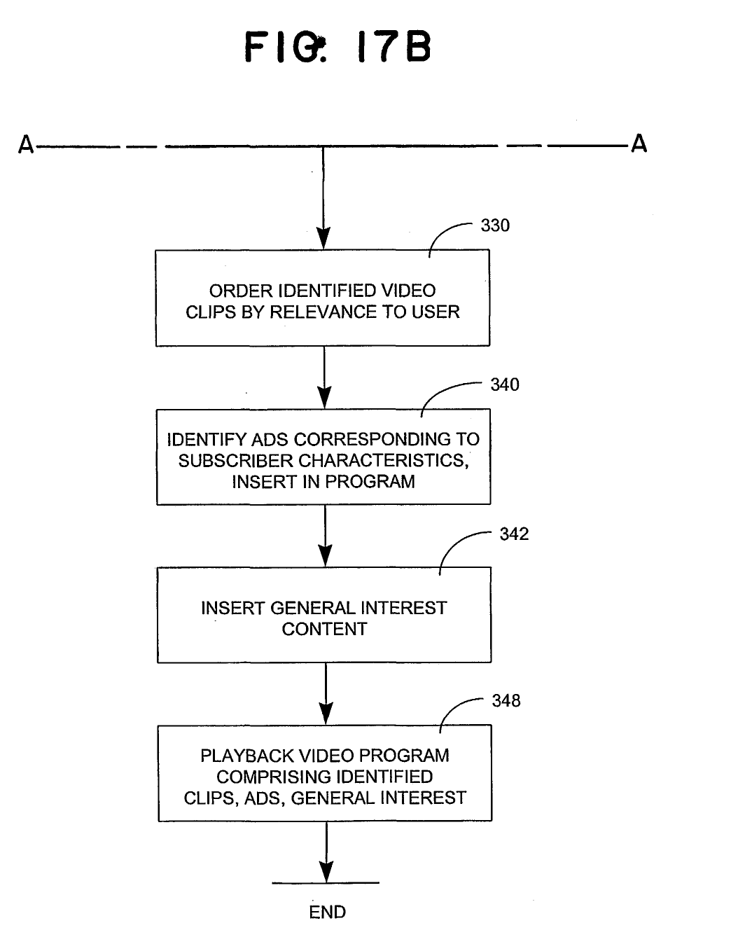

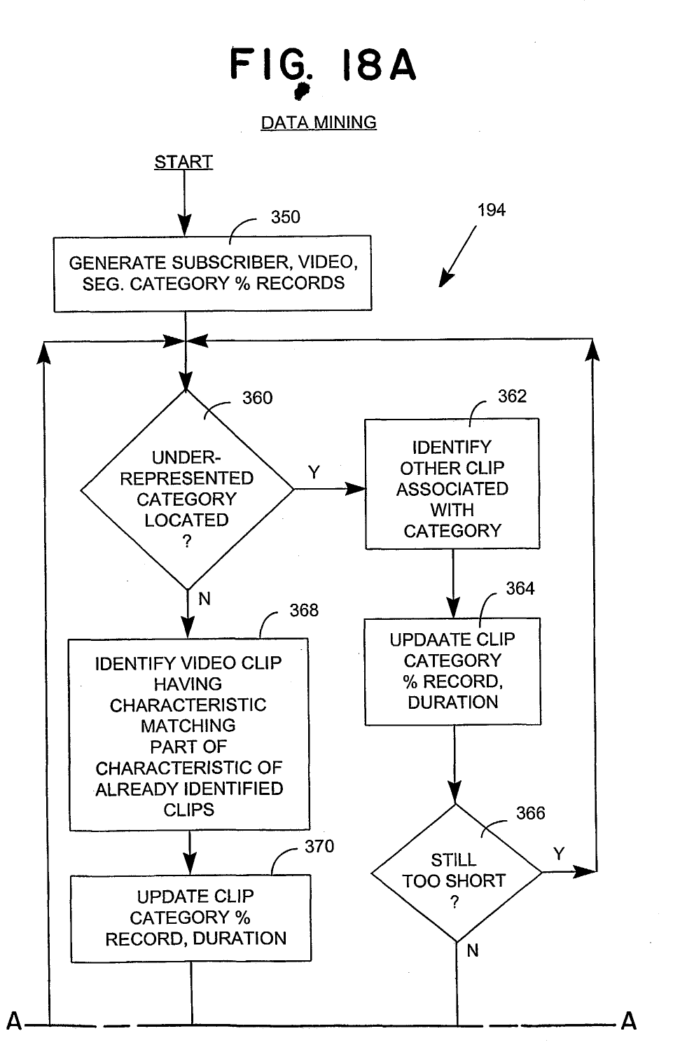

Referring to FIGS. 1, 10A, 10B, 17A and 17B, the custom newscast routine is shown in greater detail at 192 in FIGS. 17A and 17B. Generally, the custom newscast routine 192 configures the processor circuit 32 to cause video segments having information content associated with a particular subscriber and having smooth transition features, to be successively played to produce a continuous video program including the segments. Customized multimedia content is thus presented to the particular subscriber.

In this embodiment, the custom newscast routine 192 is executed automatically in response to a particular subscriber 44 logging onto the server 34, by entering the subscriber's username and password. Alternatively, the custom newscast routine may be invoked in response to a signal received from the particular subscriber after login, indicating a desire to view the customized newscast.

The custom newscast routine 192 begins with a first block of codes shown at 310 in FIGS. 17A and 17B, that configures the processor circuit 32 to identify the video segments having information content associated with the particular subscriber.

More particularly, referring to FIGS. 2, 10A, 10B, 17A and 17B, block 310 first directs the processor circuit 32 to locate a subscriber information record 55 in the subscriber information table 48 shown in FIG. 2, having username field 56 and password field 57 contents identical to the username and password supplied by the particular subscriber at login. Upon locating the subscriber information record 55, block 310 directs the processor circuit to copy the contents of the user ID field 58 into the user ID register 200 in the RAM 182 shown in FIGS. 10A and 10B.

Referring to FIGS. 3, 10A, 10B and 17A and 17B, block 310 then directs the processor circuit 32 to identify subscriber characteristics associated with the particular subscriber 44 identified by the contents of the user ID register 200. More particularly, the processor circuit is directed to locate all portfolio records 69 in the portfolio table 50 shown in FIG. 3, having user ID field 70 contents matching the contents of the user ID register 200 in the RAM 182 shown in FIGS. 10A and 10B. For each such located portfolio record 69, block 310 directs the processor circuit to append the contents of the stock symbol field 72 to the contents of the characteristics list register 202 in the RAM 182. Accordingly, following execution of block 310 the characteristics list register 202 will contain identifications of all stock symbols associated with the particular subscriber 44 identified by the contents of the user ID register 200. Such stock symbols may be stored as semicolon- or space-delimited string data, or alternatively, in any other suitable way to allow the processor circuit to distinguish one stock symbol from the next. Alternatively, if desired, other identifications of such stocks may be stored, such as contents of the stock ID field 74 of each portfolio record 69. More broadly, stocks are merely one example of subscriber characteristics that may be stored in the characteristics list register 202.

Referring to FIGS. 1, 5, 10A, 10B, 17A and 17B, block 310 further directs the processor circuit 32 to determine the time and date of the most recent usage of the server 34 by the particular subscriber 44. In this regard, block 310 directs the processor circuit to locate the usage record 113 in the usage log 54 shown in FIG. 5, having user ID field 114 contents matching the contents of the user ID register 200, and having the most recent time and date stored in the datestamp field 118. Upon locating this most recent usage record, block 310 directs the processor circuit to copy the contents of the datestamp field 118 into the last usage time/date register 204 in the RAM 182. As explained below, the processor circuit will not attempt to locate video segments prior to this last usage time/date, as the subscriber is unlikely to wish to view video segments pre-dating his previous interaction with the server 34. Alternatively, if desired, the processor circuit may be configured to locate in the usage log 54 the time and date of the last custom newscast received by the particular subscriber rather than the last interaction with the server, and to store the time and date of this most recent newscast in the last usage time/date register 204.

Referring to FIGS. 7, 1A, 10B, 17A and 17B, block 310 then configures the processor circuit 32 to access the content database 36 for content associated with at least one subscriber characteristic of the particular subscriber 44. More particularly, block 310 directs the processor circuit to search the content description table 140 shown in FIG. 7, for all content description records 142 having at least one stock symbol stored in the stock symbol field 154 matching at least one stock symbol stored in the characteristics list register 202 in the RAM 182, and having datestamp field 148 contents representing a time and date equal to or more recent than the contents of the last usage time/date register 204 in the RAM 182. Upon locating each such content description record 142, block 310 directs the processor circuit to generate a corresponding video segment record in the video program list register 206, and to copy the contents of the video ID field 144, the location link field 152 and the stock symbol field 154, to a video ID field 312, a link field 314 and a stock symbol field 315 in the new video segment record in the video program list register 206, respectively. Block 310 further directs the processor circuit to increase the contents of the total program duration register 208 (initially zero) by the contents of the time duration field 158 of the content description record 142.

Referring to FIGS. 3, 4, 10A, 10B, 17A and 17B, block 316 then directs the processor circuit 32 to generate current stock values representing the current values of the stocks associated with the particular subscriber 44. In this embodiment, block 316 directs the processor circuit to calculate total values of the particular subscriber's investment holdings. Block 316 directs the processor circuit to address each stock symbol stored in the characteristics list register 202 in the RAM 182. For each such addressed stock symbol, block 316 directs the processor circuit to locate and address the portfolio record 69 in the portfolio table 50 shown in FIG. 3 having user ID field 70 contents and stock symbol field 72 contents matching those of the user ID register 200 and the addressed stock symbol, and further directs the processor circuit to locate and address the company record 95 in the companies table 52 shown in FIG. 4 having stock symbol field 100 contents matching the addressed stock symbol. Block 316 then directs the processor circuit to multiply the contents of the quantity field 76 of the portfolio record 69 by the contents of the last trade price field 106 of the company record 95, and to store the addressed stock symbol and the resulting multiplication product in a stock symbol field 318 and a stock value field 320 respectively, of a new stock value record in the current stock values register 210.

Although calculation of such current total stock values is not necessary, it facilitates data mining for additional video segments and data weeding to eliminate superfluous video segments, and also facilitates ordering of the video segments according to relevance to the user.

Referring to FIGS. 10A, 10B, 17A and 17B, blocks 322, 324, 326 and 328 configure the processor circuit 32 to optimize the continuous video program. In this embodiment, optimizing includes optimizing a playback duration of the continuous video program. Alternatively, however, the continuous video program may be optimized in other ways, such as optimizing content, for example.

Block 322 configures the processor circuit 32 to compare a playback duration of the continuous video program to a desired playback duration. More particularly, block 322 directs the processor circuit to compare the contents of the total program duration register 208 in the RAM 182 to a predefined desired playback duration, which in this embodiment is a range of 20 to 25 minutes. Alternatively, the desired playback duration may be defined in other ways, such as other time duration ranges, or may simply include a minimum duration or a maximum duration, for example.

If the contents of the total program duration register 208 represent a playback duration that is shorter than the desired playback range, the processor circuit 32 is directed at block 324 to call the data mining subroutine 194. Effectively, the data mining subroutine 194 configures the processor circuit 32 to identify an additional video segment in the content database having information content associated with the particular subscriber, when the playback duration of the continuous video program is less than the desired playback duration. The data mining subroutine 194 continues to identify additional video segments in this manner and add them to the video program list register 206, until the playback duration of the continuous video program is no longer less than the desired playback range. The data mining subroutine is discussed in greater detail below.

If at block 322 the contents of the total program duration register 208 are not less than the desired playback range, block 326 directs the processor circuit 32 to determine whether the contents of the total program duration register 208 exceed the desired playback range. If so, the processor circuit is directed at block 328 to call the data weeding subroutine 196. Effectively, the data weeding subroutine 196 configures the processor circuit 32 to eliminate a video segment identified as having information content associated with the particular subscriber 44, when the playback duration of the continuous video program exceeds the desired playback duration. The data weeding subroutine directs the processor circuit to continue eliminating video segments in this manner until the contents of the total program duration register 208 no longer exceed the desired playback duration range. The data weeding subroutine is discussed in greater detail below.

Following execution of either the data mining subroutine 194 or the data weeding subroutine 196, or alternatively if the contents of the total program duration register 208 fall within the desired playback duration range, the processor circuit 32 is directed to block 330.

Generally, block 330 configures the processor circuit 32 to order the video segments into a playback sequence. More particularly, in this embodiment block 330 configures the processor circuit to order the video segments according to relevance of each of the segments to the particular subscriber 44. Block 330 configures the processor circuit to determine the relevance of each of the segments to the particular subscriber, in response to subscriber characteristics associated with the particular subscriber. More particularly, in this embodiment relevance is determined in response to quantities of respective investment holdings associated with the particular subscriber 44.

To achieve this, block 330 first directs the processor circuit 32 to locate the highest value in the stock value field 320 in the current stock values register 210 in the RAM 182. Block 330 then directs the processor circuit to store a plurality of relevance threshold values in the relevance thresholds register 216. In this embodiment, a first value equal to one-third of the highest value in the stock value field 320 is stored in a “medium” relevance threshold field 332 of the relevance thresholds register 216, and a second value equal to two-thirds of the highest value is stored in a “high” relevance threshold field 334.

Block 330 then directs the processor circuit 32 to sequentially address each video segment record in the video program list register 206. Block 330 directs the processor circuit to read the contents of the stock symbol field 315 of the currently addressed video segment record, and to locate all corresponding records in the current stock values register 210 having stock symbol field 318 contents matching at least one stock symbol in the stock symbol field 315. Block 330 further directs the processor to add the contents of the stock value fields 320 of any such located records, and to compare the resulting sum to the contents of the relevance thresholds register 216. If the resulting sum is less than the contents of the medium relevance threshold field 332, then a relevance value representing “low” relevance is stored in a relevance field 336 of the currently addressed video segment record in the video program list register 206. If the resulting sum is greater than or equal to the contents of the medium relevance threshold field 332 but less than the contents of the high relevance threshold field 334, then a relevance value representing “medium” relevance is stored in the relevance field 336. If the resulting sum is greater than or equal to the contents of the high relevance threshold field 334, then a relevance value representing “high” relevance is stored in the relevance field 336. Block 330 continues to direct the processor circuit to address video segment records until a relevance value has been generated and stored in the relevance field 336 of each video segment record in the video program list register 206. Alternatively, other ways of determining the relevance of each of the segments to the particular subscriber may be substituted.

Block 330 then configures the processor circuit 32 to schedule a first video segment of high relevance to the particular subscriber 44 at a commencement of the playback sequence, and to schedule a second video segment of high relevance to the particular subscriber at an end of the playback sequence. Such scheduling may be more likely to keep a particular subscriber's attention throughout the playback sequence, and may increase the likelihood that the subscriber will view entire playback sequences on future logins, rather than cutting off playback before the video program has been completely viewed.

To achieve such scheduling, block 330 directs the processor circuit to count the total number “N” of video segment records in the video program list register 206, and to locate two video segment records having a “high” relevance value in their relevance fields 336. Upon locating two such records, block 330 directs the processor circuit to store a value of “1” in a playback order field 338 of one of the video segment records indicating that it is to be played first, and to store a value equal to “N” in the playback order field 338 of the other video segment record, indicating that it is to be played last. Similarly, if only one video segment record having a “high” relevance value exists, its playback order field contents will be set to “1”, and a video segment having the next highest contents of its relevance field 336 will have its playback order field contents set to “N”. Likewise, if no “high” relevance video segments exist, the video segment records having the highest relevance values will have their playback order field contents set to indicate first and last playback respectively.

For each of the remaining video segment records in the video program list register 206, block 330 directs the processor circuit to randomly store a unique number between 2 and N−1 in the playback order field 338 of the record. Alternatively, if desired, block 330 may be modified to direct the processor circuit to store playback order values in order to “alternate” relevance, by placing “low” relevance video segments in between “medium” or “high” relevance video segments.

Finally, block 330 directs the processor circuit to sort the video segment records according to the contents of their playback order fields 338.

Referring to FIGS. 6, 1A, 10B, 17A and 17B, block 340 then configures the processor circuit 32 to cause at least one advertisement video segment to be played in the continuous video program. More particularly, in this embodiment block 340 configures the processor circuit to identify at least one advertisement video segment having information content associated with the particular subscriber. By selecting advertisements having information content associated with the subscriber, the subscriber is more likely to be interested in the content of the ads, and the advertisers are more likely to be willing to pay more money for the advertisement, as it will be shown to a target audience rather than a random audience. Alternatively, however, advertisements may be omitted entirely, or may be randomly selected.

Identification of advertisement video segments having information content associated with the particular subscriber is performed using the advertisement description table 141, and proceeds analogously to the identification of video segments described above in connection with block 310, with the exception that the most recent usage time of the particular subscriber is not used to eliminate advertisements pre-dating the subscriber's last login. If a suitable advertisement cannot be located using a procedure analogous to block 310, data mining analogous to block 324 is applied to the advertisement description table 141, and conversely, if too many relevant ads are located, data weeding analogous to block 328 is performed to reduce the number of relevant ads. As these procedures are described in detail elsewhere in this specification relating to video segments generally, such details are not repeated here as they relate to advertisement video segments.

After identifying a suitable number of advertisement video segments in the above manner, block 340 further directs the processor circuit 32 to insert a video segment record corresponding to each advertisement video segment into the video program list register 206, each such record having a unique advertisement ID stored in the video ID field 312, a location link stored in the link field 314 providing a link to the location in the advertisements database 137 of the advertisement video segment store 139 in which the advertisement video segment is stored, and a playback order number stored in the playback order field 338 indicating the position in the playback sequence of the advertisement video segment. Upon inserting each such advertisement video segment record into the video program list register 206, the processor circuit increments the contents of the playback order fields 338 of all succeeding video segment records in the sorted video program list register. In this embodiment, block 340 directs the processor circuit to insert an advertisement video segment record at every tenth position in the video program list register 206. Alternatively, however, advertisements may be inserted more or less frequently, and may be inserted based on playback duration of the segments rather than the number of segments, for example.

Referring to FIGS. 7, 1A, 10B, 17A and 17B, block 342 then configures the processor circuit 32 to cause at least one general interest video segment having information content of general interest to subscribers to be played in the continuous video program. In the present embodiment, the general interest register 218 contains one or more general interest records, each of which includes a video ID field 344 and a mandatory order field 346. The video ID field 344 stores a unique video ID codes identifying a segment identified as being of general interest to all subscribers, and the mandatory order field 346 stores a mandatory playback sequence position, if any, of the corresponding general interest segment, such as a value of “1” indicating that the general interest segment must be played at the beginning of the continuous video program, for example. Such general interest records may be entered daily by a system administrator, such as an editor-in-chief for example, using a suitable graphical interface (not shown).

For each such general interest segment record, block 342 directs the processor circuit to generate a new video segment record in the video program list register 206, by copying the video ID field 344 contents to the video ID field 312, by copying the mandatory order, if any, from the mandatory order field 346 to the playback order field 338, and by storing an appropriate link in the link field 314, which is obtained from the content description record 142 shown in FIG. 7 having video ID field 144 contents corresponding to those of the video ID field 344. Block 342 also directs the processor circuit to increment the contents of the playback order fields 338 of all succeeding video segment records.

Alternatively, general interest content may be identified in any other suitable way. For example, referring back to FIG. 7, either the journalist who initially stores a given video segment, or alternatively a system administrator at a later time, may store a wildcard value in the stock symbol field 154 of the content description database, and the wildcard value may be recognized by the processor circuit at block 310 as a command to identify the video segment as having information content associated with every subscriber, regardless of the subscriber's stock portfolio. Or, a separate general interest video program may be played immediately prior to and continuously joined to the continuous video program, for example. This may be achieved by way of a modification to a program synchronization file, discussed below, for example.

Referring to FIGS. 1, 8, 10A, 10B, 17A and 17B, block 348 then configures the processor circuit 32 to cause the video segments having information content associated with the particular subscriber 44 and having smooth transition features, to be successively played to produce the continuous video program including the segments. Block 348 first directs the processor circuit 32 to generate and store a program synchronization file in the program synchronization file register 219.

To produce the program synchronization file, block 348 directs the processor circuit 32 to successively address each video segment record in the video program list register 206, according to the contents of the playback order field 338, beginning with the record corresponding to the first video segment to be played. For each addressed video segment record, block 348 directs the processor circuit to read the contents of the link field 314 and to use such contents to address the video segment store 138 corresponding to the video segment. Block 348 then directs the processor circuit to append the contents of the SMIL file 161 of the currently addressed video segment store 138 to the contents of the program synchronization file register 219. When all video segment records in the video program list register 206 have been addressed in the above manner, the result is a single SMIL file stored in the program synchronization file register 219, including the contents of all SMIL files 161 corresponding to the video segments identified in the video program list register. This single SMIL file controls synchronized playback of each of the video segments in succession, to produce the continuous video program.

Block 348 then directs the processor circuit 32 to transmit to the particular subscriber 44, over the network 40, the single SMIL file stored in the program synchronization file register 219, along with the contents of the segment content portions 162 shown in FIG. 8 of each video segment listed in the video program list register 206.

In this embodiment, each of the subscribers 42 is equipped with software capable of executing SMIL files. More particularly, in this embodiment each subscriber 42 is equipped with RealPlayer 7, version 6.0.7.380 embedded mode, available from Real Networks.com. Alternatively, other SMIL players, such as Internet Explorer version 5.0 available from Microsoft Corporation, or QuickTime version 4.1 available from Apple Computer, Inc. for example, may be substituted. Thus, transmission of the single SMIL file stored in the program synchronization file register 219 along with the contents of the corresponding segment content portions 162, from the processor circuit 32 to the particular subscriber 44, results in execution of the SMIL file by such software, thereby causing each of the video segments identified in the video program list register to be successively played, to produce the continuous video program.

In light of the smooth transition features of the segment content portions 162 shown in FIG. 8, transmission by the processor circuit 32 of the SMIL file stored in the program synchronization file register 219 to the particular subscriber 44, causes video segments having opening and closing scenes of the video segments sufficiently dissimilar from each other to prevent jump cuts from a closing scene of one video segment to an opening scene of a following video segment, to be played, at the location of the particular subscriber 44.

Data Mining Subroutine

In this embodiment, the data mining subroutine 194 is called by the custom newscast routine 192 shown in FIGS. 17A and 17B, at block 324, after having determined at block 322 that the continuous video program is not long enough.

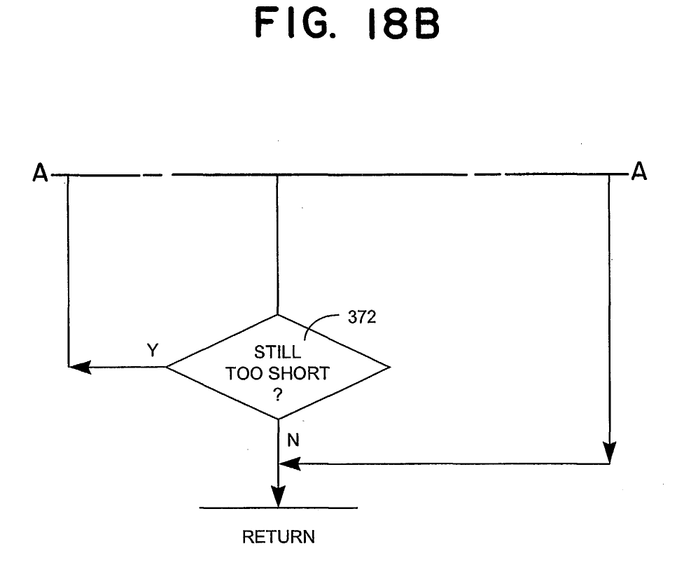

Referring to FIGS. 10A, 10B, 18A and 18B, the data mining subroutine is shown in greater detail at 194 in FIGS. 18A and 18B. Generally, the data mining subroutine 194 configures the processor circuit 32 to identify an additional video segment in the content database 36 having information content associated with the particular subscriber 44, when the playback duration of the continuous video program is less than the desired playback duration.

The data mining subroutine 194 begins with a first block of codes 350 that directs the processor circuit 32 to generate a subscriber category percentage table and a video segment category percentage table, and to store such tables in the SUB-CAT % register 212 and the VID-CAT % register 214 in the RAM 182, respectively.

Referring to FIGS. 4, 10A, 10B, 18A and 18B, to generate the subscriber category percentage table, block 350 directs the processor circuit 32 to successively address each current stock value record in the current stock values register 210. For each addressed stock value record, block 350 directs the processor circuit to use the contents of the stock symbol field 318 to locate a corresponding company record 95 in the companies table 52 shown in FIG. 4.

Block 350 then directs the processor circuit 32 to locate and address a SUBCAT % record in the SUB-CAT % register 212 having contents of a category field 352 equal to the contents of the category/sector field 104 of the company record 95, and if no such record exists, block 350 directs the processor circuit to create and address a new SUB-CAT % record having such category field 352 contents. Block 350 then directs the processor circuit to add the contents of the stock value field 320 of the currently addressed current stock values record into a percentage field 354 of the currently addressed SUB-CAT record.

When all of the records in the current stock values register 210 have been addressed in the above manner, the resulting SUB-CAT % table contains a SUB-CAT % record for each sector in which the particular subscriber 44 owns an investment holding. The category field 352 of each such SUB-CAT record identifies the industry sector, and the percentage field 354 contains a number representing the raw total value of the particular subscriber's investment holdings in that sector. Block 350 then directs the processor circuit to calculate a sum of the contents of the percentage fields 354 of all SUB-CAT % records, and to divide the contents of each percentage field 354 by this sum, so that the percentage field 354 of each SUB-CAT % record contains a value between zero and 1, expressing the dollar value of the particular subscriber's investment holdings in each industry sector as a fraction of the subscriber's total investment holdings.

Referring to FIGS. 4, 7, 10A, 10B, 18A and 18B, to generate the VID-CAT % table, block 350 directs the processor circuit 32 to address each video segment record in the video program list register 206 in succession. For each addressed video segment record, block 350 directs the processor circuit to determine a category, in this embodiment industry sector, to which the video segment record relates. In this embodiment the processor circuit determines this category by using the contents of the stock symbol field 315 of the video segment record to locate a corresponding company record 95 of the companies table 52 shown in FIG. 4, and by reading the contents of the category/sector field 104 of the corresponding company record 95. Alternatively, the category may be obtained using the contents of the video ID field 312 of the video segment record in conjunction with the category/sector field 156 of the corresponding content description record 142 in the content description table 140 shown in FIG. 7 if the category/sector field 156 is not empty, for example.

Block 350 then directs the processor circuit 32 to locate and address a VIDCAT % record in the VID-CAT % register 214 having contents of a category field 356 equal to the category of the currently addressed video segment record, as determined above, and if no such record exists, block 350 directs the processor circuit to create and address a new VID-CAT % record having such category field 356 contents. Block 350 then directs the processor circuit to use the contents of the video ID field 312 of the currently addressed video segment record to locate the corresponding segment duration value stored in the time duration field 158 of the corresponding content description record 142 shown in FIG. 7. Block 350 directs the processor circuit to divide this time duration by the contents of the total program duration register 208 in the RAM 182, and to add the result of such division to the contents of a percentage field 358 of the currently addressed VID-CAT % record.

When all of the video segment records in the video program list register 206 have been addressed in the above manner, the resulting VID-CAT % table contains a VID-CAT % record for each sector to which any of the video segments identified in the video program list register 206 relates. The category field 356 of each VID-CAT % record identifies the industry sector, and the percentage field 358 contains a number between zero and 1 representing the fraction of the duration of the continuous video program that relates to that sector.

Referring to FIGS. 10A, 10B, 18A and 18B, blocks 360 and 362 then configure the processor circuit 32 to identify a characteristic category associated with at least one subscriber characteristic, and to identify other video segments associated with the characteristic category. More particularly, in this embodiment blocks 360 and 362 configure the processor circuit to identify another video segment associated with a particular characteristic category, when the category is underrepresented in the continuous video program.

To achieve this, block 360 first directs the processor circuit 32 to compare the contents of the SUB-CAT % register 212 and the VID-CAT % register 214, to determine whether an underrepresented category in the SUB-CAT % register 212 exists. For example, in this embodiment, if 50% of the value of a subscriber's investment holdings are in the technology sector but only 20% of the duration of the continuous video program relates to the technology sector, the technology sector would be considered to be an under-represented category. Block 360 directs the processor circuit to address each record in the SUB-CAT % register 212. For each addressed SUB-CAT % record, the processor circuit is directed to subtract the contents of the percentage field 358 of a VID-CAT % record in the VID-CAT % register 214 corresponding to the same category or sector as the addressed SUB-CAT % record, from the contents of the percentage field 354 of the addressed SUB-CAT % record, to produce an under-representation value. Such under-representation values are temporarily stored in the RAM 182 in a calculation area (not shown) along with identifications of the categories or sectors to which they relate. Block 360 further directs the processor circuit to determine whether any of the underrepresentation values is positive and exceeds a threshold underrepresentation value, such as 0.1, for example, indicating a potentially noticeable under-representation of the category or sector in the continuous video program.

Referring to FIGS. 4, 7, 10A, 10B, 18A and 18B, if any positive under-representation values greater than the threshold are detected at block 360, block 362 directs the processor circuit 32 to identify the under-represented category or sector to which the greatest positive under-representation value relates, and to identify another video segment associated with that category. In this regard, block 362 directs the processor circuit to successively address the content description records 142 in the content description table 140 shown in FIG. 7. If the contents of the category/sector field 156 of the content description record 142 correspond to the under-represented category or sector, block 362 directs the processor circuit to determine whether the video ID stored in the video ID field 144 matches a video ID already stored in the video ID field 312 of the video program list register 206, and if not, block 362 directs the processor circuit to add a new video segment record to the video program list register, and to copy the contents of the video ID field 144, the location link field 152 and the stock symbol field 154, to the video ID field 312, the link field 314 and the stock symbol field 315 respectively in the new video segment record.

If the contents of the category/sector field 156 of the currently addressed content description record 142 are empty, block 362 directs the processor circuit 32 to use the contents of the stock symbol field 154 to look up the category in the category/sector field 104 of the company record 95 in the companies table 52 corresponding to the addressed content description record. If this category corresponds to the under-represented category and the segment is not already listed in the video program list register 206, a new video segment record is created in the video program list register 206 corresponding to the content description record 142, as described above.

If no additional content description records can be located in the content description table 140 corresponding to the under-represented category, block 362 then directs the processor circuit 32 to search the content description database 130 for a video segment associated with the category to which the next-greatest under-representation value corresponds. If no such record corresponding to any of the under-representation values can be located, block 362 directs the processor circuit to go to block 368, described below.

After identifying another video segment and adding a corresponding video segment record to the video program list register 206 in the above manner, block 364 directs the processor circuit 32 to update the contents of the VIDCAT % register 214 and the total program duration register 208 to reflect the addition of the new video segment to the continuous video program.

Referring to FIGS. 10A, 10B, 17A, 17B, 18A and 18B, block 366 then directs the processor circuit 32 to compare the revised contents of the total program duration register 208 to the desired playback duration, as described above in connection with block 326 of the custom newscast routine 192, to determine whether the continuous video program is still too short. If so, the processor circuit is directed back to block 360 above. If not, the data mining subroutine 194 is ended and the processor circuit is directed to return to block 330 of the custom newscast routine 192.

Referring to FIGS. 7, 1A, 10B, 18A and 18B, if at block 360 no category or sector was identified as being under-represented in the continuous video program by at least the threshold under-representation percentage, block 368 configures the processor circuit 32 to identify another video segment in response to a video segment characteristic of a video segment already identified as having information content associated with the particular subscriber. More particularly, in this embodiment, block 368 directs the processor circuit to address a first video segment record in the video program list register 206. Block 368 directs the processor circuit to use the contents of the video ID field 312 of the video segment record to locate the corresponding content description record 142 in the content description table 140 shown in FIG. 7. The processor circuit is then directed to read the contents of the description field 146, and to search the content description table 140 for other content description records 142 having at least some description field 146 contents matching the description field 146 contents of the currently addressed record.

For example, assuming that the currently addressed description field 146 contains a description “WirelessMD Inc. and Glenayre Technologies, Inc. Announce Strategic Alliance”, and corresponds to a video segment that has already been added to the video program list register 206 because the particular subscriber 44 owns stock in WirelessMD but not in Glenayre, and assuming that another content description record 142 has description field 146 contents relating to Glenayre, such as “OfficeDomain, Glenayre Technologies Enable Complete Wireless Message Management on Handspring Visor” for example, block 368 directs the processor circuit to create a new video segment record in the video program list register 206 corresponding to this latter content description record 142, in the manner previously described.

Alternatively, rather than merely searching for partial matches among the description fields 146, the processor circuit may be directed to identify another video segment in response to any other video segment characteristic or combination of video segment characteristics of a video segment already identified as having information content associated with the particular subscriber 44. For example, contents of one or more of the fields 146, 148, 150, 154, 156, 158 or 159 may be used for this purpose, or alternatively, other video segment characteristics may be used.

After identifying another video segment and adding a corresponding video segment record to the video program list register 206 in the above manner, block 370 directs the processor circuit to update the contents of the VID-CAT register 214 and the total program duration register 208 to reflect the addition of the new video segment to the continuous video program.

Referring to FIGS. 10A, 10B, 17A, 17B, 18A and 18B, block 372 then directs the processor circuit 32 to compare the revised contents of the total program duration register 208 to the desired playback duration, as described above in connection with block 326 of the custom newscast routine 192, to determine whether the continuous video program is still too short. If so, the processor circuit is directed back to block 360 above. If not, the data mining subroutine 194 is ended and the processor circuit is directed to return to block 330 of the custom newscast routine 192.

Data Weeding Subroutine

In this embodiment, the data weeding subroutine 196 is called by the custom newscast routine 192 shown in FIGS. 17A and 17B, at block 328, after having determined at block 326 that the continuous video program is too long.

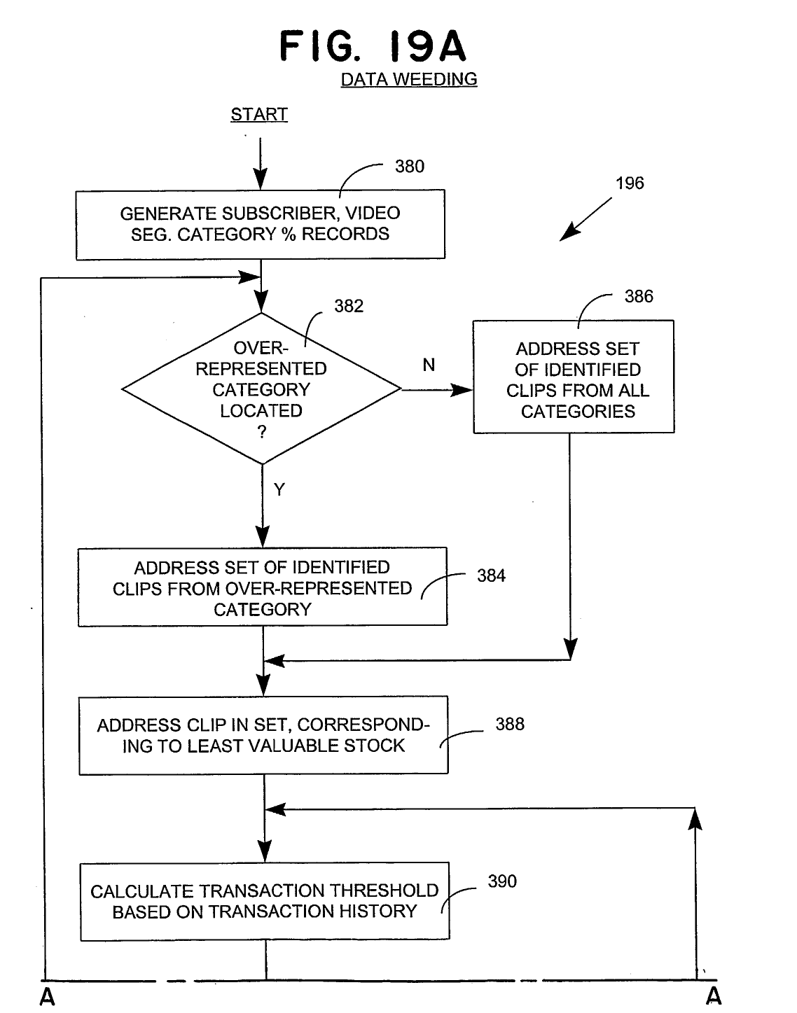

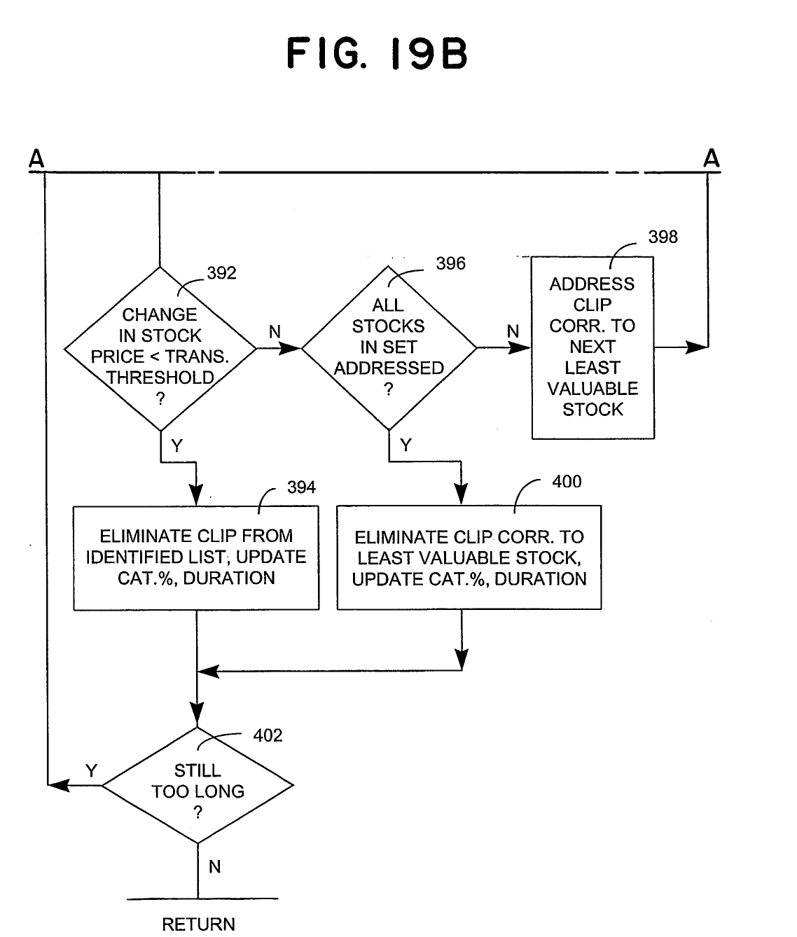

Referring to FIGS. 10A, 10B, 19A and 19B, the data weeding subroutine is shown in greater detail at 196 in FIGS. 19A and 19B. Generally, the data weeding subroutine 196 configures the processor circuit 32 to eliminate a video segment identified as having information content associated with the particular subscriber 44, when the playback duration of the continuous video program exceeds the desired playback duration.

The data weeding routine 196 begins with a first block of codes 380, that directs the processor circuit 32 to generate a subscriber category percentage table and a video segment category percentage table, and to store such tables in the SUB-CAT % register 212 and the VID-CAT % register 214 in the RAM 182, respectively. This procedure is identical to that described in greater detail above in connection with block 350 of the data mining routine 194.

In this embodiment, blocks 382 and 384 effectively configure the processor circuit 32 to eliminate from the program a video segment associated with a particular characteristic category, when the category is over-represented in the continuous video program.

Block 382 then directs the processor circuit 32 to compare the contents of the SUB-CAT % register 212 and the VID-CAT % register 214, to determine whether an over-represented category in the SUB-CAT % register 212 exists. For example, in this embodiment, if 30% of the duration of the video program relates to the mining sector, but only 4% of the value of the particular subscriber's investment holdings consists of mining sector stocks, the mining sector would be considered to be over-represented. Block 382 directs the processor circuit to address each record in the SUB-CAT % register 212. For each addressed SUB-CAT % record, the processor circuit is directed to subtract the contents of the percentage field 354 of the currently addressed SUB-CAT % record, from the contents of the percentage field 358 of a VIDCAT % record in the VID-CAT % register 214 corresponding to the same category or sector as the addressed SUB-CAT % record, to produce an overrepresentation value. Such over-representation values are temporarily stored in the RAM 182 in a calculation area (not shown) along with identifications of the categories or sectors to which they relate. Block 382 further directs the processor circuit to determine whether any of the over-representation values is positive and exceeds a threshold over-representation value, such as 0.1, for example, indicating a potentially noticeable over-representation of the category or sector in the continuous video program.

If a noticeably over-represented category is identified at block 382, block 384 directs the processor circuit 32 to address a set of video segment records consisting only of those video segment records in the video program list register 206 corresponding to the over-represented category, for the remainder of the execution of the data weeding routine, until the next time (if any) that block 382 is executed. Thus, the first video segment to be eliminated from the video program will be a video segment associated with the over-represented category.

If a noticeably over-represented category is not identified at block 382, block 386 directs the processor circuit to address a set of video segment records comprising all video segment records in the video program list register 206, for the remainder of the execution of the data weeding routine, until the next execution (if any) of block 382.

Block 388 then directs the processor circuit 32 to address the video segment record from among the set of records addressed at block 384 or 386, corresponding to the least valuable stock in the portfolio of the particular subscriber 44, as determined from the contents of the current stock values register 210 and the stock symbol field 315.

Referring to FIGS. 3, 10A, 10B, 19A and 19B, blocks 390 to 400 configure the processor circuit 32 to eliminate from the video program a video segment associated with a particular subscriber characteristic, in response to a transaction history associated with the particular subscriber and with the particular subscriber characteristic. More particularly, in this embodiment blocks 392 to 398 configure the processor circuit to eliminate a video segment when a change in a dynamic value associated with the particular subscriber characteristic is less than a threshold value derived from the transaction history.

Block 390 directs the processor circuit 32 to calculate a transaction threshold value relating to the stock identified in the currently addressed video segment record in the video program list register 206. To achieve this, block 390 directs the processor circuit to locate the portfolio record 69 in the portfolio table 50 shown in FIG. 3 corresponding to the user ID of the particular subscriber 44 and having stock symbol field 72 contents matching the contents of the stock symbol field 315 of the currently addressed video segment record. Block 390 then directs the processor circuit to read the contents of the transaction history field 78 of the located portfolio record 69. The processor circuit is then directed to determine a transaction threshold value, representing a change in share price which is likely to prompt the particular subscriber 44 to buy or sell the stock. More particularly, block 390 directs the processor circuit to calculate an average, over the entire transaction history, of the absolute magnitude of the difference between the contents of the price field 88 of one individual transaction field 80 and the contents of the price field 88 of the next individual transaction field 80. In other words, the transaction threshold value may be calculated as:

$$\frac{{\sum }_{x = 2}^{N} \vert {P}_{x} - {P}_{x - 1} \vert}{N - 1}$$

where N is the number of non-zero individual transaction fields 80 in the transaction history field 78, and Px=the contents of the price field 88 of the _{xf″} individual transaction field 80. Block 390 directs the processor circuit to store this transaction threshold value in a calculation area (not shown) in the RAM 182.

Referring to FIGS. 3, 4, 10A, 10B, 19A and 19B, block 392 then directs the processor circuit 32 to determine the change in share price of the stock since the particular subscriber's most recent transaction, and to determine whether or not this change in share price exceeds the transaction threshold value. More particularly, block 392 directs the processor circuit to use the contents of the stock symbol field 315 of the currently addressed video segment record to locate the corresponding company record 95 in the companies table 52 shown in FIG. 4, and to calculate, as the change in chare price, the absolute value of a difference between the contents of the last trade price field 106 of the company record 95, and the price field 88 of the N _{t″} or most recent individual transaction field 80 in the transaction history field 78 of the corresponding portfolio record 69.

If this change in share price is less than the transaction threshold value as determined above, block 394 directs the processor circuit 32 to eliminate the currently addressed video segment record from the video program list register 206. Block 394 further directs the processor circuit to update the contents of the VID-CAT % register 214 and the total program duration register 208 to reflect the elimination of the video segment from the continuous video program.

However, if at block 392, the change in share price is not less than the transaction threshold value, block 396 directs the processor circuit 32 to determine whether all video segment records in the set of records addressed at block 384 or 386 have been tested at block 392. If they have not, block 398 directs the processor circuit to address the next video segment record corresponding to the next least valuable stock in the particular subscriber's portfolio, as determined from the contents of the current stock values register 210 and the stock symbol field 315, and the processor circuit is directed back to block 390 to calculate a transaction threshold value corresponding to the stock to which the newly-addressed video segment record relates, as indicated by its stock symbol field 315.

If, at block 396, all video segment records in the set of records addressed at block 384 or 386 have been tested at block 392, then block 400 directs the processor circuit 32 to eliminate the video segment record from the currently addressed set of records, corresponding to the least valuable stock, as indicated by the contents of the stock symbol field 315 of the video segment records and the contents of the current stock values register 210. Block 400 further directs the processor circuit to update the contents of the VID-CAT % register 214 and the total program duration register 208 to reflect the elimination of the video segment from the continuous video program.

Referring to FIGS. 10A, 10B, 17A, 17B, 19A and 19B, following elimination of a video segment record from the video program list register 206 at either block 294 or block 400, block 402 directs the processor circuit 32 to determine whether the continuous video program is still too long, by determining whether the contents of the total program duration register 208 exceed the desired playback range, as described above in connection with block 326 of the custom newscast routine 192. If the video program is still too long, the processor circuit is directed back to block 382 to identify another video segment to be eliminated. If the video program is not too long, the data weeding routine 196 is ended and the processor circuit is directed to return to block 330 of the custom newscast routine 192.

Alternatives

Data Mining and Data Weeding

Referring back to FIGS. 18A and 18B, although block 362 of the data mining subroutine 194 has been described in the context of identifying video segments associated with an underrepresented category, alternatively, block 362 could be implemented without such a constraint. For example, an alternative embodiment of the data mining subroutine involves deletion of block 360, and execution of a modified block 362 that configures the processor circuit 32 to identify a characteristic category associated with the at least one subscriber characteristic, and to identify other video segments associated with the characteristic category.

For example, in one alternative embodiment the modified block 362 determines an industry sector corresponding to a stock associated with the particular subscriber, and identifies another video segment associated with the industry sector. The current stock values register 210, or alternatively a portfolio record 69, is used to identify a stock symbol associated with the subscriber. A company record 95 corresponding to the stock symbol, in the companies table 52, is used to identify the sector. Either the category/sector field 156 of the content description table 140, or alternatively the stock symbol field 154 in conjunction with the category/sector field 104 of the companies table 52, is used to identify additional video segments associated with the sector.

Similarly, although the data mining subroutine 194 and the data weeding subroutine 196 were each described as being called by the custom newscast routine 192 in response to determining that the continuous video program is either too short or too long respectively; alternatively, such subroutines may be desirable even if the video program is not necessarily too long or too short. Thus, the processor circuit 32 may be configured to optimize the video program by adjusting a proportion of content of the continuous video program in response to subscriber characteristics associated with the particular subscriber.

For example, even if the video program is not too short, the processor circuit 32 may be configured to add to the continuous video program a video segment associated with a particular characteristic category, when the category is underrepresented in the continuous video program, in a manner similar to that shown in FIGS. 18A and 18B. Conversely, even if the video program is not too long, the processor circuit may be configured to eliminate from the continuous video program a video segment associated with a particular characteristic category, when the category is overrepresented in the continuous video program.

Artificial Intelligence

Referring back to FIGS. 10A and 10B, the storage medium 184 is also used to store program codes for directing the processor circuit 32 to execute an artificial intelligence routine 199. Although various specific linkages and interrelationships between data fields of records contained in the subscriber database 38 and the content database 36 have been discussed herein, alternatively, the artificial intelligence routine 199 may be executed by the processor circuit 32, to direct the processor circuit to identify additional interrelationships between any of the data fields disclosed herein. Such additional interrelationships may be particularly advantageous for modifications of the data mining subroutine 194 for example, to direct the processor circuit 32 to execute the artificial intelligence routine 199 to identify additional video segments having information content associated with a particular subscriber. However, the artificial intelligence routine 199 may also be used more broadly, to determine additional interrelationships for potential use by the processor circuit in any of the routines, subroutines and threads disclosed herein.

While specific embodiments of the invention have been described and illustrated, such embodiments should be considered illustrative of the invention only and not as limiting the invention as construed in accordance with the accompanying claims.

What is claimed is:

1. A method of presenting customized multimedia content, the method comprising causing video segments having information content associated with a particular subscriber and having smooth transition features, to be successively played to produce a continuous video program comprising the segments.

2. The method of claim 1 further comprising identifying said video segments having information content associated with said particular subscriber.

3. The method of claim 2 wherein identifying comprises accessing a content database for content associated with at least one subscriber characteristic of said particular subscriber.

4. The method of claim 3 further comprising storing, in a subscriber database, at least one said subscriber characteristic associated with each said particular subscriber of a plurality of subscribers.

5. The method of claim 4 further comprising acquiring at least some of said subscriber characteristics from said subscribers.

6. The method of claim 4 wherein storing said at least one subscriber characteristic comprises storing an identification of an investment holding of said particular subscriber.

7. The method of claim 6 wherein storing said at least one subscriber characteristic further comprises storing an identification of at least one transaction made by said particular subscriber relating to said investment holding.

8. The method of claim 4 further comprising monitoring communications between said particular subscriber and a service, and wherein storing said at least one subscriber characteristic comprises producing a usage log of usage of said service by said particular subscriber.

9. The method of claim 8 wherein producing said usage log comprises recording a uniform resource locator specified by said particular subscriber.

10. The method of claim 8 wherein producing said usage log comprises recording at least some source code associated with a resource identified by a uniform resource locator specified by said particular subscriber.

11. The method of claim 3 further comprising optimizing said continuous video program.

12. The method of claim 11 wherein optimizing comprises eliminating from said program a video segment associated with a particular characteristic category, when said category is overrepresented in said continuous video program.

13. The method of claim 11 wherein optimizing comprises eliminating from said program a video segment associated with a particular subscriber characteristic, in response to a transaction history associated with said particular subscriber and with said particular subscriber characteristic.

14. The method of claim 13 wherein eliminating a video segment comprises eliminating said video segment when a change in a dynamic value associated with said particular subscriber characteristic is less than a threshold value derived from said transaction history.

15. The method of claim 11 wherein optimizing comprises adjusting a proportion of content of said continuous video program in response to subscriber characteristics associated with said particular subscriber.

16. The method of claim 15 wherein adjusting comprises adding to said continuous video program a video segment associated with a particular characteristic category, when said category is underrepresented in said continuous video program.

17. The method of claim 15 wherein adjusting comprises eliminating from said continuous video program a video segment associated with a particular characteristic category, when said category is overrepresented in said continuous video program.

18. The method of claim 1 further comprising ordering said video segments into a playback sequence.

19. The method of claim 18 wherein ordering comprises ordering said video segments according to relevance of each of said segments to said particular subscriber.

20. The method of claim 19 further comprising determining said relevance of each of said segments to said particular subscriber, in response to subscriber characteristics associated with said particular subscriber.

21. The method of claim 20 wherein determining relevance comprises determining relevance in response to quantities of respective investment holdings associated with said particular subscriber.

22. The method of claim 19 wherein ordering comprises scheduling a first video segment of high relevance to said particular subscriber at a commencement of said playback sequence, and scheduling a second video segment of high relevance to said particular subscriber at an end of said playback sequence.

23. The method of claim 1 wherein causing to be successively played comprises causing at least one general interest video segment having information content of general interest to subscribers to be played in said continuous video program.

24. The method of claim 1 further comprising causing at least one advertisement video segment to be played in said continuous video program.

25. The method of claim 2 wherein identifying comprises identifying at least one advertisement video segment having information content associated with said particular subscriber.

26. The method of claim 1 further comprising storing said video segments having said smooth transition features in a content database.

27. The method of claim 26 wherein storing said video segments comprises storing video segments having, as said smooth transition features, opening and closing scenes of said video segments sufficiently dissimilar from each other to prevent jump cuts from a closing scene of one video segment to an opening scene of a following video segment.

28. The method of claim 1 wherein causing comprises causing to be successively played video segments having opening and closing scenes of said video segments sufficiently dissimilar from each other to prevent jump cuts from a closing scene of one video segment to an opening scene of a following video segment.

29. An apparatus for presenting customized multimedia content, the apparatus comprising a processor circuit configured to cause video segments having information content associated with a particular subscriber and having smooth transition features, to be successively played to produce a continuous video program comprising the segments.

30. The apparatus of claim 29 wherein said processor circuit is configured to identify said video segments having information content associated with said particular subscriber.

31. The apparatus of claim 30 further comprising a content database in communication with said processor circuit, wherein said processor circuit is configured to access said content database for content associated with at least one subscriber characteristic of said particular subscriber.

32. The apparatus of claim 31 further comprising a subscriber database in communication with said processor circuit, wherein said processor circuit is configured to store in said subscriber database at least one said subscriber characteristic associated with each said particular subscriber of a plurality of subscribers.

33. The apparatus of claim 32 wherein said processor circuit is configured to acquire at least some of said subscriber characteristics from said subscribers.

34. The apparatus of claim 32 wherein said processor circuit is configured to store, as said at least one subscriber characteristic, an identification of an investment holding of said particular subscriber.

35. The apparatus of claim 34 wherein said processor circuit is further configured to store, as said at least one subscriber characteristic, an identification of at least one transaction made by said particular subscriber relating to said investment holding.

36. The apparatus of claim 32 wherein said processor circuit is configured to monitor communications between said particular subscriber and a service, and to produce and store, as said at least one subscriber characteristic, a usage log of usage of said service by said particular subscriber.

37. The apparatus of claim 36 wherein said processor circuit is configured to record in said usage log a uniform resource locator specified by said particular subscriber.

38. The apparatus of claim 36 wherein said processor circuit is configured to record in said usage log at least some source code associated with a resource identified by a uniform resource locator specified by said particular subscriber.

39. The apparatus of claim 31 wherein said processor circuit is configured to optimize said continuous video program.

40. The apparatus of claim 39 wherein said processor circuit is configured to compare a playback duration of said continuous video program to a desired playback duration.

41. The apparatus of claim 40 wherein said processor circuit is configured to identify an additional video segment in said content database having information content associated with said particular subscriber, when said playback duration of said continuous video program is less than said desired playback duration.

42. The apparatus of claim 41 wherein said processor circuit is configured to identify a characteristic category associated with said at least one subscriber characteristic, and to identify other video segments associated with said characteristic category.

43. The apparatus of claim 41 wherein said processor circuit is configured to identify another video segment associated with a particular characteristic category, when said category is underrepresented in said continuous video program.

44. The apparatus of claim 41 wherein said processor circuit is configured to identify another video segment in response to a video segment characteristic of a video segment already identified as having information content associated with said particular subscriber.

45. The apparatus of claim 40 wherein said processor circuit is configured to eliminate a video segment identified as having information content associated with said particular subscriber, when said playback duration of said continuous video program exceeds said desired playback duration.

46. The apparatus of claim 45 wherein said processor circuit is configured to eliminate from said program a video segment associated with a particular characteristic category, when said category is overrepresented in said continuous video program.

47. The apparatus of claim 45 wherein said processor circuit is configured to eliminate from said program a video segment associated with a particular subscriber characteristic, in response to a transaction history associated with said particular subscriber and with said particular subscriber characteristic.

48. The apparatus of claim 47 wherein said processor circuit is configured to eliminate said video segment when a change in a dynamic value associated with said particular subscriber characteristic is less than a threshold value derived from said transaction history.

49. The apparatus of claim 39 wherein said processor circuit is configured to adjust a proportion of content of said continuous video program in response to subscriber characteristics associated with said particular subscriber.

50. The apparatus of claim 49 wherein said processor circuit is configured to add to said continuous video program a video segment associated with a particular characteristic category, when said category is underrepresented in said continuous video program.

51. The apparatus of claim 49 wherein said processor circuit is configured to eliminate from said continuous video program a video segment associated with a particular characteristic category, when said category is overrepresented in said continuous video program.

52. The apparatus of claim 29 wherein said processor circuit is configured to order said video segments into a playback sequence.

53. The apparatus of claim 52 wherein said processor circuit is configured to order said video segments according to relevance of each of said segments to said particular subscriber.

54. The apparatus of claim 53 wherein said processor circuit is configured to determine said relevance of each of said segments to said particular subscriber, in response to subscriber characteristics associated with said particular subscriber.

55. The apparatus of claim 54 wherein said processor circuit is configured to determine said relevance in response to quantities of respective investment holdings associated with said particular subscriber.

56. The apparatus of claim 53 wherein said processor circuit is configured to schedule a first video segment of high relevance to said particular subscriber at a commencement of said playback sequence, and to schedule a second video segment of high relevance to said particular subscriber at an end of said playback sequence.

57. The apparatus of claim 29 wherein said processor circuit is configured to cause at least one general interest video segment having information content of general interest to subscribers to be played in said continuous video program.

58. The apparatus of claim 29 wherein said processor circuit is configured to cause at least one advertisement video segment to be played in said continuous video program.

59. The apparatus of claim 30 wherein said processor circuit is configured to identify at least one advertisement video segment having information content associated with said particular subscriber.

60. The apparatus of claim 29 further comprising a content database in communication with said processor circuit, said content database storing said video segments having said smooth transition features.

61. The apparatus of claim 60 wherein said smooth transition features of said video segments comprise opening and closing scenes of said video segments sufficiently dissimilar from each other to prevent jump cuts from a closing scene of one video segment to an opening scene of a following video segment.

62. The apparatus of claim 21 wherein said processor circuit is configured to cause to be successively played video segments having opening and closing scenes of said video segments sufficiently dissimilar from each other to prevent jump cuts from a closing scene of one video segment to an opening scene of a following video segment.

63. An apparatus for presenting customized multimedia content, the apparatus comprising:
a) means for causing video segments having information content associated with a particular subscriber and having smooth transition features, to be successively played to produce a continuous video program comprising the segments; and
b) means for identifying said video segments having information content associated with said particular subscriber.

64. A computer readable medium for providing instructions for directing a processor circuit to present customized multimedia content, by causing video segments having information content associated with a particular subscriber and having smooth transition features, to be successively played to produce a continuous video program comprising the segments.

65. A signal embodied in a carrier wave, the signal comprising a code segment for directing a processor circuit to cause video segments having information content associated with a particular subscriber and having smooth transition features, to be successively played to produce a continuous video program comprising the segments.
